(19) United States
(12) Patent Application Publication
(10) Pub. No.: US 2018/0275058 A1
(43) Pub. Date: Sep. 27, 2018

(54) SYSTEMS AND METHODS FOR MULTIPLEXED DETECTION OF BIOMARKERS

(71) Applicant: SeLux Diagnostics, Inc., Watertown, MA (US)

(72) Inventors: Eric STERN, Watertown, MA (US); Aleksandar VACIC, Watertown, MA (US); Nathan B. PURMORT, Watertown, MA (US)

(21) Appl. No.: 15/756,938

(22) PCT Filed: Sep. 2, 2016
(86) PCT No.: PCT/US16/50156

§ 371 Date: Mar. 1, 2018

Related U.S. Application Data
(60) Provisional application No. 62/213,430, filed on Sep. 2, 2015.
(60) Provisional application No. 62/264,246, filed on Dec. 7, 2015.
(60) Provisional application No. 62/264,248, filed on Dec. 7, 2015.
(60) Provisional application No. 62/264,252, filed on Dec. 7, 2015.
(60) Provisional application No. 62/318,163, filed on Apr. 4, 2016.

(51) Int. Cl. G01N 21/64; B01L 3/00; G01J 3/44; G01N 21/69; G01N 21/76

(52) U.S. Cl. CPC G01N 21/6428; B01L 3/502715; G01J 3/4406; G01N 21/6452; G01N 21/69; G01N 2021/6482; B01L 2400/0487; B01L 2200/0605; B01L 2400/06; B01L 2300/0681; G01N 21/76

(57) ABSTRACT

In some aspects, reader systems for optically detecting binding agents or analyte complexes in a sample as a result of performing biochemical assays can include: a housing defining a positioning receptacle to receive the sample; an excitation source to generate incident light directed at the sample; at least one solid-state photomultiplier detector configured to: i) receive a light emitted by at least one label associated with the binding agents and/or analyte complexes within the sample; and ii) produce a signal in response to receiving the light emitted by the at least one label or substrate solution that is physically or chemically modified by the said label, the at least one detector being connected to integrated signal processing electronics to process the signal; and a user interface in communication with the signal processing electronics for conveying one or more results of the one or more biochemical as says.

### RELATED APPLICATIONS

This application claims benefit of U.S. Provisional Patent Application Ser. No. 62/213,430 filed Sep. 2, 2015, entitled “Systems and Methods for Multiplexed Detection of Biomarkers,” U.S. Provisional Patent Application Ser. No. 62/264,246 filed Dec. 7, 2015, entitled “Integrated Blood Filtration Device for Microfluidic Assays and Associate Methods,” U.S. Provisional Patent Application Ser. No. 62/264,248 filed Dec. 7, 2015, entitled “Microfluidic Device for Precise Volume Definition, Metering, and Mixing and Methods Thereof,” and U.S. Provisional Patent Application Ser. No. 62/264,252 filed Dec. 7, 2015, entitled “Systems and Methods for Optical Feedback for Precise and Accurate Measurement of Dilution Factor in Microfluidic Assays,” the contents of which are hereby incorporated by reference in their entirety.

This application also relates to U.S. Provisional Patent Application Ser. No. 62/142,721, filed on Apr. 3, 2015 and entitled “Assay Methods Involving Dissociable Nanoparticles,” U.S. Provisional Patent Application Ser. No. 62/174,957, filed on Jun. 12, 2015 and entitled “Parallel Detection of Biomarkers and Uses Thereof,” U.S. patent application Ser. No. 14/809,116, filed on Jul. 24, 2015 and entitled “Assay Methods Involving Dissociable Nanoparticles,” U.S. Provisional Patent Application Ser. No. 62/194,046 filed on Jul. 17, 2015 and entitled “Dissociable Transition-Metal Nanoparticles,” and U.S. Provisional Patent Application Ser. No. 62/053,251 filed on Sep. 22, 2014 and entitled “Centrifugal Fluid Chip for Fluid Assays,” the contents of which are hereby incorporated by reference in their entirety.

### TECHNICAL FIELD

This application relates generally optically detecting biomarkers. Specifically, this application relates to a low-cost optics platform for parallel detection of biomarkers and more particularly to point of care devices for assisted reproduction technology (ART).

### BACKGROUND

Current practice in Assisted Reproduction Technology (ART) comprises repeated patient monitoring of blood levels for two key reproductive hormones, estradiol (E2) and progesterone (P4), during a patient's in vitro fertilization (IVF) cycle. This procedure involves an average of 3-6 trips to a clinic during the 2-week Controlled Ovarian Hyperstimulation (COH) period before Egg Retrieval. Recognition that more patient-friendly ART is needed in IVF clinics has led to various technologies, including self-administration of gonadotropins, newer gonadotropin formulations, milder stimulation protocols (Wang J, Sauer MV. In vitro fertilization (IVF): a review of 3 decades of clinical innovation and technological advancement. Ther Clin Risk Manag. 2, 355-64 (2006)), reduction of multiple pregnancies by judicious single embryo transfer (Gerris J, et al. Elective single day 3 embryo transfer halves the twinning rate without decrease in the ongoing pregnancy rate of an IVF/ICSI programme. Hum Reprod. 17, 2626-31 (2002)), and efficacious embryo freezing programs (Tiitinen A, et al. What is the most relevant standard of success in assisted reproduction. The value of cryopreservation on cumulative pregnancy rates per single oocyte retrieval should not be forgotten. Hum Reprod. 19, 2439-41 (2004)). However, these innovations lack the ability to be carried out in the home, away from the physician's office, or are expensive.

Accurate and reliable reproductive hormone measurements are critical for successful ART procedures. Specifically, in the case of IVF, precise quantitative measurements of E2 and P4 are required on a regular basis in order to optimize patient outcomes. The low hormone concentrations—E2 levels must be accurately detected to ˜100 pM during COH—require use of high-sensitivity assays, with enzyme linked immunosorbent assays (ELISAs) being the most common.

The ELISA is a decades-old platform that utilizes antibodies for molecular recognition and an enzyme label to amplify a small signal to easily detectable thresholds. Originally designed for protein detection, the technology is used for small molecule sensing in a “competitive” format. In the case of E2, the sample is mixed with a buffer containing an E2-enzyme conjugate and, during an incubation period, the conjugate and free E2 in the sample compete for binding to an immobilized antibody. Unbound species are then removed by a series of washes, followed by the introduction of a signal development solution that activates the enzyme. The activated enzyme catalyzes a reaction that produces a measurable optical signal. Because of the competitive format, the strength of the optical signal is inversely correlated to E2 concentration.

In spite of the sensitivity and specificity of ELISAs, which makes them ubiquitous in clinical and research labs, their critical reliance on a naturally-occurring peroxidase renders them a delicate technique that requires precise reagent monitoring and storage and trained operators. Since the measured signal is dependent entirely on the enzyme's performance consistency, reagents must be carefully tracked, shipped, and stored, and tests require constant control samples to ensure accurate quantification. For comparison, the non-enzyme-based pregnancy immunoassay is readily available on drug store shelves.

Currently, a challenge to ART treatments is the limited access worldwide. Many women cannot undergo IVF procedures because blood monitoring is not easily available within a reasonable distance from homes. While this is the case in large, developed societies, such as the USA, it is also a problem in the developing world where ARTs are scarce, though rising. Additionally, the added stress of travel to clinics, loss of time from employment, and repetitive venipuncture can impact the success of an IVF cycle and continuation of treatment. Even in younger (e.g., under 35 years-old) patients, when IVF success rates are at their pinnacle, more than 30% of women drop out of treatment, although the procedure is covered by health insurance.

Thus, there is a need to significantly increase patient access to IVF treatment, in addition to easing the burden of the procedure. There is also a need for a POC platform capable of delivering rapid results (e.g., hormone levels, analyte levels) without the need for repetitive venipunctures to improve patient comfort.

### SUMMARY

In some aspects, reader systems for optically detecting binding agents and/or analyte complexes in a sample as a result of performing one or more biochemical assays can include a housing defining a positioning receptacle configured to receive the sample; an excitation source to generate incident light directed at the sample; at least one solid-state photomultiplier detector configured to: i) receive a light emitted by at least one label associated with the binding agents and/or analyte complexes within the sample or from a substrate solution chemically or physically modified by the label; and ii) produce a signal in response to receiving the light, the at least one detector being connected to integrated signal processing electronics to process the signal; and a user interface in communication with the signal processing electronics for conveying one or more results of the one or more biochemical assays.

Embodiments can include one or more of the following features or elements.

The excitation source can include a light emitting diode. The excitation source can include a laser or a laser diode. The incident light can include narrow band light. The incident light can include broadband excitation light. The excitation light can include light at a wavelength of about 280 nm to about 800 nm. The excitation source can be modulated. The excitation light source and signal processing electronics can be synchronized with one another using a trigger signal. The signal can include a fluorescence optical signal. The signal can include a luminescence optical signal. The luminescence optical signal can include a chemiluminescence optical signal. The chemiluminescence optical signal can include an electrochemiluminescence optical signal. The signal can include an absorbance optical signal. The detector signal can be amplified using voltage or charge sensitive pre-amplifier. The signal processing can include photon counting, photon counting histogram, charge integration, pulse-height spectroscopy, energy spectroscopy, and/or lock-in amplification. An analyte concentration can be correlated to a signal processing output. The at least one label can include released contents of an engineered nanoparticles. The integrated signal processing electronics can include at least one of an amplifier, a signal shaping amplifier, a signal height discriminator, a field-programmable gate array chipset, microcontroller, or a microprocessor. The signal processing can be implemented digitally on an FPGA or DSP comprising algorithms for zero-pole cancellation, shaping, timing, pulse counting and/or pulse integration. The reader system can include a transmitter configured to communicate with an external network. The sample can be disposed in an optically transparent element disposed within the reader system. The optically transparent element comprises a microwell plate. The reader system can further include a microfluidic cartridge configured to receive the sample. The housing can include one or more articulation features to cause or limit fluid flow through the cartridge. The one or more articulation features can include at least one of a pneumatic actuator, a hydraulic actuator, a solenoid or motor driven actuator, a cam actuator, an electrostatic actuator, and/or a thermal actuator. The user interface can include a display. The solid-state photomultiplier can include a silicon photomultiplier. The modulated light can be pulsed for a duration of about 10 picoseconds to about 1 second. The reader system can include at least one optical element to manipulate light directed to, or emitted from the sample. The at least one optical element can include at least one of a filter, an objective, a lens, a mirror, a dichroic mirrors, fiber optics components, or a grating.

In some aspects, systems for facilitating performance of one or more biochemical assays on a sample can include a microfluidic cartridge sized and shaped to be received within a corresponding reader can include a substrate body; at least one inlet on the substrate body to receive the sample; a microfluidic network to distribute fluids through the cartridge; and an assay chamber in which a portion of the sample is disposed and can be combined with one or more binding agents and/or analyte complexes so that the biochemical assay can be performed; and a reader system that includes a housing defining a positioning receptacle to receive and couple to the cartridge; an excitation source to generate incident light directed at the assay chamber within the cartridge; at least one solid-state photomultiplier detector configured to: i) receive a light emitted by at least one label associated with the binding agents and/or analyte complexes within the sample or from a substrate solution chemically or physically modified by the label; and ii) produce a signal in response to receiving the light, the at least one detector being connected to integrated signal processing electronics to process the signal; and a user interface in communication with the signal processing electronics for conveying one or more results of the one or more biochemical assays.

Embodiments can include one or more of the following features or elements.

The excitation source can include a light emitting diode. The excitation source can include a laser. The excitation source can include a laser diode. The excitation source can include a narrow band source. The excitation source can include a broadband source. The incident light can include excitation light. The incident light generated by the excitation source can be pulsed for a duration of about 10 picoseconds to about 1 second. The system comprises at least one optical element to manipulate light directed to, or emitted from the sample. The at least one optical elements can include at least one of a filter, an objective, a lens, a mirror, a dichroic mirrors, fiber optics components, or a grating. The at least one silicon photomultiplier detector can include a cooled detector. The system can further include at least one detector that is a photodiode, an avalanche photodiode, a photodiode array, a CMOS sensor, or a single photon avalanche detector. The signal from the detector can be amplified using voltage or charge sensitive pre-amplifier and the amplified signal can be filtered to limit high frequency noise. The at least one label associated with the binding agent and/or analyte complexes can include at least one label that is bound to and/or released from the one or more binding agent and/or analyte complexes. The integrated signal processing electronics can include at least one of an amplifier, a signal shaping amplifier, a signal height discriminator, a field-programmable gate array chipset, microcontroller, or a microprocessor. The system can further include a transmitter configured to communicate with an external network. The external network can include a cloud network system or the Internet. The user interface can include a touchscreen display. The housing can include one or more articulation features to cause or limit fluid flow through the cartridge. The microfluidic cartridge can include a metering chamber in which a predefined volume of fluid can be formed. The microfluidic cartridge can include a valve upstream or downstream of the metering chamber to limit flow of the fluid into the metering chamber. The reader can include an actuator to operate the valve between an open state and a closed state. The actuator can include one or a combination a pneumatic actuator, a hydraulic actuator, a solenoid or motor driven actuator, a cam actuator, an electrostatic actuator, and/or a thermic actuator. The microfluidic cartridge can include an overflow channel through which the fluid can flow to bypass entering the metering chamber. The fluid bypasses entering the chamber in response to a valve downstream of the metering chamber being closed to limit flow of the fluid into the metering chamber. The fluid bypasses entering the chamber in response to a valve upstream of the metering chamber being closed to limit flow of the fluid into the metering chamber. The microfluidic cartridge can include a waste chamber for storing biohazardous waste. The microfluidic cartridge can include more than one inlet and/or a manifold to receive more than one fluid for distribution throughout the microfluidic network. The cartridge can include binding agents and/or analyte complexes that are immobilized on a surface of the assay chamber. The binding agents and/or analyte complexes can be immobilized on a plurality of magnetic beads. The plurality of magnetic beads can be stored off-cartridge and sized and shaped for injection through one of the at least one port on the cartridge. An external magnetic field can be used to localize magnetic beads. The microfluidic cartridge can be substantially free of wet reagents. The wet reagents can be stored in a separate reservoir disposed within the housing. The solid-state photomultiplier can be a silicon photomultiplier. The signal can be a fluorescence optical signal. The signal can include a luminescence optical signal. The luminescence optical signal can include a chemiluminescence optical signal. The chemiluminescence optical signal can include an electrochemiluminescence optical signal. The signal can include an absorbance optical signal.

In some aspects, single-use microfluidic cartridges to be inserted within a corresponding reader system for optically detecting binding agents or analyte complexes in a sample as a result of performing one or more biochemical assays, the microfluidic cartridge that includes a cartridge body that is sized and shaped to be received within an opening of corresponding reader, the cartridge body comprising: at least one inlet to receive one or more fluids, the one or more fluids comprising the sample; a metering module configured to produce a predetermined volume of the sample from at least one of the at least one inlets, the metering module comprising a valve to selectively limit flow of the sample the assay chamber; an assay chamber in which a portion of the sample is disposed and can be combined with one or more binding agents and/or analyte complexes so that the biochemical assay can be performed; a microfluidic network to distribute fluids through the cartridge; and a pressure generating device to cause fluid to flow through the microfluidic network from the inlet to the assay chamber.

Embodiments can include one or more of the following features or elements.

The metering module can include a metering chamber in which a predefined volume of fluid can be formed. The valve can be disposed downstream of the metering chamber to limit flow of the fluid into the metering chamber. The valve can be disposed upstream of the metering chamber to limit flow of the fluid into the metering chamber. The valve can be configured to be operated between an open state and a closed state by an external actuator. The external actuator can include one or a combination a pneumatic actuator, a hydraulic actuator, a solenoid or motor driven actuator, a cam actuator, an electrostatic actuator, and/or a thermic actuator disposed in or on the corresponding reader system. The microfluidic cartridge can include an overflow channel through which the fluid can flow to bypass entering the metering chamber. The fluid bypasses entering the chamber in response to the valve being closed to limit flow of the fluid into the metering chamber. The microfluidic cartridge can include a waste chamber for storing biohazardous waste. The at least one inlet can include more than one inlet and/or a manifold to receive more than one fluid. The single-use microfluidic cartridge can further include binding agents and/or analyte complexes that are immobilized on a surface of the assay chamber. The binding agents and/or analyte complexes can be immobilized on a plurality of magnetic beads. The assay chamber can serve as a dilution chamber. The assay chamber serves as a portion of the metering module. The assay chamber can be or include a metering chamber in which a volume of the sample is measured. A portion of the cartridge can include an optical detection zone within at least a portion of the assay chamber. The detection zone can be substantially optically transparent. The substantially optically transparent can include light transmission that is greater than about 80%. The microfluidic cartridge is substantially free of wet reagents. The microfluidic cartridge comprises a dried or lyophilized reagent that can be reconstituted. The single-use microfluidic cartridge can further include a filtering module to separate a fluid sample. The single-use microfluidic cartridge can further include a dilution module. The dilution module can further include a ratiometric mixing module.

Described herein are also systems and methods that can be used for parallel detection of various biomarkers in a biological sample for diagnosis, prognosis and therapeutic use. For example, the systems and methods herein can be used to monitor and/or optimize treatment of Assisted Reproductive Technology (ART), evaluate the status of multiple biomarkers, and determine progression and prognosis. Systems and methods including devices comprising detectors, microfluidics, and bioassays can be used for point-of-care (POC) testing to both improve the quality of care for patients with various diseases and lower cost.

In some aspects, systems for detecting an optical signal (e.g., fluorescent optical signal) can include a cartridge that is sized and shaped for insertion into a reader and is capable of performing one or more biochemical assays (e.g., immunoassays, nucleic acid assays); comprising at least one binding agent (e.g., antibody, ssDNA, aptamer), wherein the at least one binding agent binds to at least one analyte in a biological sample to form one or more binding agent/analyte complexes, wherein the one or more binding agent/analyte complexes are then detected optically with at least one label (e.g., enzyme, engineered nanoparticles, chemiluminophore, chemiluminophore precursor), wherein an optical signal is produced when the at least one label is bound to the one or more binding agent/analyte complexes; and the reader comprising: a housing; an excitation light source (e.g., a light emitting diode (LED)) that generates incident light (e.g., further including excitation light) (e.g., wherein the excitation light is in an ultraviolet, visible and/or near-infrared range (e.g., from 250 nm to 1000 nm)); a detector or array of detectors (e.g., a solid-state photomultiplier (e.g., a silicon photomultiplier)) that receives light emitted by at least one label that is bound to and/or released from the one or more binding agent/analyte complexes (e.g., released contents of eNP) and that produces a corresponding signal that can be further processed using signal processing electronics (e.g., voltage or charge sensitive amplifier, signal shaping amplifier, signal height discriminator, analog to digital converter, a field-programmable gate array (FPGA) chipset, digital signal processor (DSP)), microcontroller and/or a microprocessor; a transmitter; and a display (e.g., a touchscreen) for visually displaying one or more results of the one or more biochemical assay(s).

In some embodiments, a signal from a detector (e.g., a solid-state photomultiplier (e.g., a silicon photomultiplier)) can be amplified using a charge or voltage sensitive amplifier (e.g., the amplifier is physically next to the detector to minimize noise) and can be immediately converted into digital form (i.e., digitized) using an analog-to-digital converter (e.g., >100 MSPS). The digitized signal can then be processed digitally using pulse processing algorithms implemented as algorithms on a microprocessor or specialized chipset (e.g., field-programmable gate array (FPGA) or digital signal processing (DSP)) instead of discrete components (e.g., zero-pole cancellation, pulse shaping, timing filters, baseline restoration, trapezoidal and triangular filters, etc.).

In some embodiments, prior to digitization, the signal may be passed through a low-pass filter to limit bandwidth and high frequency noise.

In some aspects, a system for detecting an optical signal (e.g., chemiluminescent optical signal, e.g., absorbance) can include a cartridge that is sized and shaped for insertion into a reader and is capable of performing one or more biochemical assays (e.g., immunoassays, nucleic acid assays); comprising at least one binding agent (e.g., antibody, ssDNA, aptamer), wherein the at least one binding agent binds to at least one analyte in a biological sample to form one or more binding agent/analyte complexes, wherein the one or more binding agent/analyte complexes are then detected optically with at least one label (e.g., enzyme, engineered nanoparticles, chemiluminophore, chemiluminophore precursor), wherein an optical signal is produced when the at least one label is bound to the one or more binding agent/analyte complexes; and the reader comprising: a housing; a detector or array of detectors (e.g., silicon photomultiplier) that receives light emitted by at least one label that is bound to and/or released from the one or more binding agent/analyte complexes (e.g., released contents of eNP) and that produces a corresponding signal that can be further filtered (e.g., Nyquist filter) and using pulse processing algorithms implemented as algorithms on a microprocessor or specialized chipset (e.g., FPGA or DSP) (e.g., zero-pole cancellation, pulse shaping, timing filters, baseline restoration, trapezoidal and triangular filters, etc.), microcontroller and/or a microprocessor; a transmitter; and a display (e.g., a touchscreen) for visually displaying one or more results of the one or more biochemical assay(s).

In some embodiments, the one or more biochemical assay(s) comprise an immunoassay, a nucleic acid assay, and/or a multiplexed set of assays. In some embodiments, the one or more biochemical assay(s) comprise one or more amplification steps. In some embodiments, the one or more biochemical assay(s) comprise engineered nanoparticles.

In some embodiments, the optical signal is a member selected from the group consisting of fluorescence, chemiluminescence, and absorbance.

In some embodiments, the reader comprises optical elements (e.g., filters, objectives, lenses, mirrors, dichroic mirrors, fiber optics, gratings, multiple detectors or arrays of detectors, etc.).

In some embodiments, the detector or array of detectors is shaped and sized to receive a signal generated by emitted or transmitted light that is electrically amplified using one or more amplifiers (e.g., comprising transimpedance, transconductance, charge-sensitive, shaping, or a combination thereof).

In some embodiments, the signal processing comprises photon counting, photon counting histogram, charge integration, pulse-height spectroscopy, energy spectroscopy, and/or lock-in amplification.

In some embodiments, a programmable gain wideband voltage sensitive amplifier (e.g., Texas instruments LMH6881) is used to amplify the signal with minimal distortion followed by a high speed analog-to-digital converter (e.g., >100 MSPS, e.g., Analog Devices AD9230BCPZ-250). Signal is then stored in memory where it can be accessed by a digital signal processor (DSP) or an FPGA. A timestamp can then be created using one of the following three methods: 1. Leading edge timing (e.g., timestamp can be generated after pulse crossing of a preprogrammed or user defined threshold voltage); 2. Crossover timing (e.g., the signal can be shaped into bipolar signal using digital RC—(CR)^{N} filter; trigger is generated at zero crossover); 3. Constant fraction timing (e.g., constant fraction discriminator). Using a timing trigger, an incoming pulse can be located and pulse pile-up can be detected and removed using rejection algorithms.

In some embodiments, photon count (i.e., photon flux) can be determined by measuring the rate of trigger signals. Optimal sensitivity can be achieved by plotting dark count (i.e., response of a detector (e.g., silicon photomultiplier) versus timing threshold voltage described above).

In some embodiments, digital pulse processing can encompass a specific combination of the following filters, such as zero-pole cancellation, shaping (e.g., Gaussian, bipolar, RC—(CR)^{N}, etc.), timing, trapezoidal, triangular, etc.

In some embodiments, the reader comprises a volume less than 1 cubic foot and a mass that is less than 10 kg. In some embodiments, the reader further comprises a graphical user interface. In some embodiments, the reader is sized and shaped to transmit encrypted data to a remote database for processing, storage, and/or future access.

In some embodiments, the reader can be used to read luminescent (e.g., fluorescent, chemiluminescent, etc.) signal from a microplate (e.g., a microwell plate (e.g., a 6-, 24-, 96-, 384- or 1536-well format plate)) wherein a single or multiple sensors (e.g., parallel readout) can be used. In case of single sensor readout, appropriate mechanical stage allows x-y movements of microtiter plates. In case of simultaneous readout, a linear or two-dimensional array of sensors can be used.

In some embodiments, the cartridge comprises microfluidic and/or chromatographic elements (e.g., lateral or vertical flow assay(s)). In some embodiments, the cartridge is disposable and comprises plastic, membranes, filters, adhesives, and no active components. In some embodiments, some or all reagents are stored off-cartridge.

In some embodiments, a microfluidic cartridge can include a detection chamber, an overflow path, and a normally open valve that can be closed using external force (e.g., air pressure, mechanical plunger, etc.). The detection chamber can serve for one or a combination of the following steps: fluid metering (e.g., precise volume definition), assay incubation, and luminescent signal generation. The use of an overflow and a valve helps to provide for a simpler design of input manifold and to reduce a need for high precision pumps or other methods of dispensing precise fluid volumes since a chamber with an overflow path and valve can uniquely and repeatably measure volumes.

In some embodiments, detection occurs off-cartridge in an optically transparent element contained within the reader. In some embodiments, the optical signal is indicative of at least one analyte linked to fertility, general heath, cancer/oncology, dialysis, cardiology, neurology, infectious disease, pediatrics, allergy, immunology, emergency medicine, obstetrics and gynecology, endocrinology, psychiatry, internal medicine, nephrology, ophthalmology, orthopedics, neonatology, vascular medicine, podiatry, public health, surgery, urology, and/or the microbiome. In some embodiments, the at least one analyte is estradiol, progesterone, follicle-stimulating hormone, human chorionic gonadotropin, thyroid stimulating hormone, anti-Mullerian hormone, or testosterone.

In some embodiments, the microfluidic cartridge is substantially free of wet reagent storage. For example, the wet reagents can be stored in a separate container. In some cases, the wet reagents in the separate container can be replaced after a certain period of time (e.g., every 2 weeks).

In some embodiments, substantially all (e.g., all) necessary fluids are stored off-chip (e.g., not on the cartridge) and can be delivered using an external manifold, valves (e.g., miniature solenoid valves) and pumps (e.g., diaphragm pumps) wherein pumps can move fluids by generating positive or negative pressure. An example is depicted in FIG. 10 discussed below.

In some embodiments, calibration can be performed periodically, such as daily, weekly, monthly, or every six months. The calibration may be performed using calibrator chip. In some embodiments, the calibration can be performed using a reference luminescent solution.

In some embodiments, the detector or array of detectors can include a cooled or uncooled semiconductor based photodetector (e.g., silicon photomultiplier, photodiode, avalanche photodiode, photodiode array, CMOS or CCD sensor, or single photon avalanche detector).

In some embodiments, the incident light generated by the excitation light source signal (e.g., LED) can be modulated (e.g., pulsed, e.g., wherein a duration of the pulse is from 10 ps to 1 s).

In some embodiments, the excitation light source, detector, and signal processing electronics can be synchronized using a gate signal.

In some aspects, a microfluidic assay cartridge can be shaped and sized for insertion into a reader for detection of at least one analyte in a biological sample. The cartridge can include a housing; at least one port shaped and sized for receiving biological sample and reagents; one or more microfluidic channels; and at least one zone in which biological sample contacts one or more binding agents.

In some embodiments, the one or more binding agents can be immobilized on a surface of the cartridge. In some embodiments, the one or more binding agents can be immobilized on a plurality of magnetic beads (e.g., wherein, the plurality of magnetic beads are stored off-cartridge and sized and shaped for injection through one of the at least one ports on the cartridge and selective capture via a magnetic field).

In some embodiments, the cartridge further comprises a detection zone, wherein the detection zone is optically transparent (e.g., transmission greater than 80% (e.g., greater than 95%)) for a selected wavelength.

In some embodiments, the one or more binding agents bind one or more analytes linked to fertility, general heath, cancer/oncology, dialysis, cardiology, neurology, infectious disease, pediatrics, allergy, immunology, emergency medicine, obstetrics and gynecology, endocrinology, psychiatry, internal medicine, nephrology, ophthalmology, orthopedics, neonatology, vascular medicine, podiatry, public health, surgery, urology, and/or the microbiome.

In some embodiments, the at least one analyte is estradiol, progesterone, follicle-stimulating hormone, human chorionic gonadotropin, thyroid stimulating hormone, anti-Mullerian hormone, or testosterone.

In some embodiments, the microfluidic cartridge can be shelf stable at temperatures of at least 25° C. for at least 6 weeks.

In some embodiments, the cartridge is a single-use product.

In some aspects, a reader for analyzing a biological sample can be sized and shaped for receiving a microfluidic cartridge. The reader can include a housing; an excitation light source (e.g., a light emitting diode (LED)) that generates incident light in a range from 250 nm to 1000 nm); optics that transmit and focus light from the excitation light source and/or a detector or array of detectors (e.g., silicon photomultiplier); the detector or array of detectors (e.g., silicon photomultiplier) that receives light emitted by at least one label that is bound to and/or released from the one or more binding agent/analyte complexes (e.g., released contents of eNP) and that produces a corresponding signal via integrated signal processing electronics (e.g., amplifier, signal shaping amplifier, signal height discriminator, a field-programmable gate array (FPGA) chipset or e.g., voltage or charge sensitive amplifier followed by analog to digital conversion and digital pulse processing algorithms and filters (zero-pole cancellation, shaping (e.g., Gaussian, RC—(CR)N), trapezoidal, timing, trigger generation (e.g., leading edge discriminator, constant fraction discriminator)) implemented digitally on a microprocessor, a DSP or an FPGA or a combination thereof), microcontroller and/or a microprocessor; a data transmitter (e.g., Bluetooth, WiFi, LAN, etc.); and a display (e.g., a touchscreen (e.g., an LCD with a touch screen)) for visually displaying one or more results of the one or more biochemical assay(s).

In some aspects, a reader for analyzing a biological sample can be sized and shaped for receiving a microfluidic cartridge. The reader can include a housing; various optics for focusing light emitted from the cartridge; a detector or array of detectors (e.g., silicon photomultiplier) that receives light emitted by at least one label that is bound to and/or released from the one or more binding agent/analyte complexes (e.g., released contents of eNP) and that produces a corresponding signal via integrated signal processing electronics (e.g., amplifier, signal shaping amplifier, signal height discriminator, a field-programmable gate array (FPGA) chipset), microcontroller and/or a microprocessor; a transmitter; and a display (e.g., a touchscreen) for visually displaying one or more results of the one or more biochemical assay(s).

In some aspects, methods for detecting an optical signal indicative of a physical or mental condition (e.g., fertility) from a biological sample can include receiving, in a microfluidic cartridge (e.g., of any one of claims 19 to 27), the biological sample from a subject (e.g., wherein the cartridge can include at least one mixing zone in which the biological sample and a capturing agent can be mixed and exposed to a binding agent, wherein after exposure to the binding agent, unbound material is removed (e.g., washed (e.g., via air or liquid pulses)) causing determination of at least one analyte concentration by an optical signal (e.g., to be measured by a reader)); receiving the cartridge in a reader (e.g., one or the readers discussed herein) following receipt of the biological sample into the cartridge; detecting an optical signal via a detector or array of detectors (e.g., silicon photomultiplier) from emitted or transmitted light from a label (e.g., light from a binding/reaction event induced by the label or other species); processing the optical signal (e.g., via photon counting, photon counting histogram, charge integration, pulse-height spectroscopy, energy spectroscopy, lock-in amplification); and transmitting and/or displaying data (e.g., encrypted data) corresponding to results of at least one biochemical assay(s) (e.g., transmitting encrypted data to a remote database for processing, storage, and/or future access).

In some embodiments, the cartridge includes at least one immunoassay or nucleic acid assay (e.g., DNA/RNA). At least one assay can include an amplification-based assay. In some cases, the amplification-based assay can include a plurality of engineered nanoparticles (eNPs), for example, immobilized thereupon or therewithin. Each of the plurality of eNPs can include an encapsulated reactive core within a protective shell that, upon exposure to a trigger, such as UV light, the protective shell can be removed and the reactive core generates an optical signal. The plurality of eNPs can be functionalized to bind to at least one analyte in a biological sample.

In some embodiments, the at least one biochemical assay comprises engineered nanoparticles as labels.

In some embodiments, the method further includes monitoring at least one analyte (e.g., hormone levels, e.g., E2 and/or P4) over a period of time (e.g., two weeks). In some cases, wet reagents that are stored in a separate container can be replaced after the period of time (e.g., every two weeks).

In some embodiments, the optical signal can be electrically amplified using one or more amplifiers, which can include transimpedance, transconductance, charge-sensitive, shaping, or a combination thereof.

Unless otherwise stated or understood, the various features and aspects described herein can be combined and implemented in any of various combinations to carry out the claims filed herewith.

### Definitions

In order for the present disclosure to be more readily understood, certain terms are first defined below. Additional definitions for the following terms and other terms are set forth throughout the specification.

In this application, the use of “or” means “and/or” unless stated otherwise. As used in this application, the term “comprise” and variations of the term, such as “comprising” and “comprises,” are not intended to exclude other additives, components, integers or steps. As used in this application, the terms “about” and “approximately” are used as equivalents. Any numerals used in this application with or without about/approximately are meant to cover any normal fluctuations appreciated by one of ordinary skill in the relevant art. In some embodiments, the term “approximately” or “about” refers to a range of values that fall within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value).

“Biocompatible”: The term “biocompatible”, as used herein is intended to describe materials that do not elicit a substantial detrimental response in vivo. In some embodiments, the materials are “biocompatible” if they are not toxic to cells. In some embodiments, materials are “biocompatible” if their addition to cells in vitro results in less than or equal to 20% cell death, and/or their administration in vivo does not induce inflammation or other such adverse effects. In some embodiments, materials are biodegradable.

“Biodegradable”: As used herein, “biodegradable” materials are those that, when introduced into cells, are broken down by cellular machinery (e.g., enzymatic degradation) or by hydrolysis into components that cells can either reuse or dispose of without significant toxic effects on the cells. In some embodiments, components generated by breakdown of a biodegradable material do not induce inflammation and/or other adverse effects in vivo. In some embodiments, biodegradable materials are enzymatically broken down. Alternatively or additionally, in some embodiments, biodegradable materials are broken down by hydrolysis. In some embodiments, biodegradable polymeric materials break down into their component polymers. In some embodiments, breakdown of biodegradable materials (including, for example, biodegradable polymeric materials) includes hydrolysis of ester bonds. In some embodiments, breakdown of materials (including, for example, biodegradable polymeric materials) includes cleavage of urethane linkages.

“Biomolecule”: As used herein, “biomolecule” refers to bioactive, diagnostic, and prophylactic molecules. Biomolecules that can be used in accordance with the systems and methods herein include, but are not limited to, synthetic, recombinant or isolated peptides and proteins such as antibodies and antigens, receptor ligands, enzymes, and adhesion peptides; nucleotides and polynucleic acids such as DNA and antisense nucleic acid molecule; activated sugars and polysaccharides; bacteria; viruses; and chemical drugs such as antibiotics, antiinflammatories, and antifungal agents.

“Detector”: As used herein, the term “detector” includes any detector of electromagnetic radiation, chemiluminescence, absorbance, etc., including, but not limited to, a solid-state photomultiplier (e.g., a silicon photomultiplier), CCD camera, photomultiplier tubes, photodiodes, and avalanche photodiodes.

“Sensor”: As used herein, the term “sensor” includes any sensor of electromagnetic radiation, chemiluminescence, absorbance, etc., including, but not limited to, a solid-state photomultiplier (e.g., a silicon photomultiplier), CCD camera, photomultiplier tubes, photodiodes, and avalanche photodiodes, unless otherwise evident from the context.

“Subject”: As used herein, the term “subject” includes humans and mammals (e.g., mice, rats, pigs, cats, dogs, and horses). In many embodiments, subjects are mammals, particularly primates, especially humans. In some embodiments, subjects are livestock such as cattle, sheep, goats, cows, swine, and the like; poultry such as chickens, ducks, geese, turkeys, and the like; and domesticated animals particularly pets such as dogs and cats. In some embodiments (e.g., particularly in research contexts) subject mammals will be, for example, rodents (e.g., mice, rats, hamsters), rabbits, primates, or swine such as inbred pigs and the like.

“Therapeutic agent”: As used herein, the phrase “therapeutic agent” refers to any agent that has a therapeutic effect and/or elicits a desired biological and/or pharmacological effect, when administered to a subject.

“Treatment”: As used herein, the term “treatment” (also “treat” or “treating”) refers to any administration of a substance that partially or completely alleviates, ameliorates, relives, inhibits, delays onset of, reduces severity of, and/or reduces incidence of one or more symptoms, features, and/or causes of a particular disease, disorder, and/or condition. Such treatment can be of a subject who does not exhibit signs of the relevant disease, disorder and/or condition and/or of a subject who exhibits only early signs of the disease, disorder, and/or condition. Alternatively or additionally, such treatment can be of a subject who exhibits one or more established signs of the relevant disease, disorder and/or condition. In some embodiments, treatment can be of a subject who has been diagnosed as suffering from the relevant disease, disorder, and/or condition. In some embodiments, treatment can be of a subject known to have one or more susceptibility factors that are statistically correlated with increased risk of development of the relevant disease, disorder, and/or condition.

Drawings are presented herein for illustration purposes, not for limitation.

### BRIEF DESCRIPTION OF DRAWINGS

The foregoing and other objects, aspects, features, and advantages of the present disclosure will become more apparent and better understood by referring to the following description taken in conduction with the accompanying drawings, in which:

FIG. 1A is a perspective view of an example microfluidic cartridge and reader device.

FIG. 1B is a schematic illustration of an example engineered nanoparticle (eNP), depicting various layers.

FIG. 2A-2C are schematics of example reader system configurations, depicting different orientation possibilities for excitation sources and detectors relative to a sample to be analyzed.

FIG. 3A is a side view of an example cartridge and reader used to analyze a sample within the cartridge. FIG. 3B is a chart depicting test results for normalized fluorescence measurements using a silicon photomultiplier detector compared to a conventional commercial photomultiplier tube system using fluorescein solution. FIG. 3C is a chart depicting test results comparing the systems and methods described herein (e.g., SeLux systems) and SpectraMax M2 for E2 and P4 assay standards.

FIG. 4A is a chart depicting test results comparing example eNP performance in sandwich assay as compared to standard ELISA and W-doped TNPs (W-TNPs) alone. FIG. 4B is a chart depicting test results showing improved detection limit of ELISA (Clostridium difficile Toxin A) using example assays described herein with eNPs loaded with TAML and traditional horseradish peroxidase (HRP) ELISA.

FIG. 5 is a chart depicting test results showing DNA detection using example prototypes and assays.

FIG. 6 is a chart depicting test results showing storage stability of example eNPs described herein as compared with standard ELISA.

FIG. 7A-7D is a top view of an example microfluidic cartridge illustrating a volume definition chamber with overflow channel.

FIGS. 8A-8C are schematics of an example stop valve that can be used for volume definition in a metering chamber as described herein.

FIG. 9. is a chart depicting test results for valve leak rates as a function of pressure differential between fluid and air pressure used for driving the valve.

FIG. 10 is a perspective view of an example fluid manifold used for delivery of various fluids to a microfluidic cartridge.

FIG. 11 is a schematic of an example reader hardware system.

FIG. 12 is a schematic of example pulse processing algorithms used for photon counting, pulse height, and charge histograms.

FIG. 13 is a schematic illustrating an example sequence for digitizing a solid-state photomultiplier (e.g., a silicon photomultiplier) pulse using an analog-to-digital converter.

FIG. 14 is a schematic illustrating an example trigger and gate signal generation sequence using a variable threshold comparator that detects leading edge of input signal. The same or similar signal can be generated using digital pulse processing algorithms.

FIG. 15 is a schematic illustrating an example trigger generation sequence using zero-crossover of a bipolar signal generated using signal shaping using CR—(RC)^{N} shaping. The filter can be implemented either as hardware or software solution.

FIG. 16 is a schematic illustrating an example bipolar signal generation sequence using constant fraction discriminator, which can be implemented as hardware or software solution. Zero cross-over described in FIG. 15 can be used.

FIG. 17 is a schematic illustrating an example digital processing of signals from a solid-state photomultiplier (e.g., a silicon photomultiplier) that permits one to collect useful information about photon flux by measuring signal rate and height (either via trapezoidal filter or charge integration).

FIGS. 18a-d are flow charts depicting example detection methods as described herein that can be implemented either as hardware or software solution on an FPGA or DSP.

FIG. 19A is a schematic diagram of an example reader device.

FIG. 19B is a schematic diagram of another example reader device.

FIG. 20 is a schematic of another example reader device hardware design.

FIG. 21 is a block diagram of an example microfluidic cartridge device.

FIG. 22 is an exploded perspective view of an example microfluidic cartridge device.

FIGS. 23A-23C depicted another example of a metering chamber valve having a capillary valve.

FIG. 24 is a perspective view of an example sample filtration module.

FIG. 25 is a perspective view of the sample filtration module of FIG. 24 extracting plasma from whole blood.

FIG. 26 is a perspective view of an example sample dilution module.

FIG. 27 is a block diagram of an example network environment for use in the methods and systems for analysis of spectrometry data, according to an illustrative embodiment.

FIG. 28 is a block diagram of an example computing device and an example mobile computing device, for use in illustrative embodiments of the invention.

### DETAILED DESCRIPTION

Throughout the description, where compositions are described as having, including, or comprising specific components, or where methods are described as having, including, or comprising specific steps, it is contemplated that, additionally, there are compositions of the present invention that consist essentially of, or consist of, the recited components, and that there are methods according to the present invention that consist essentially of, or consist of, the recited processing steps.

It should be understood that the order of steps or order for performing certain action is immaterial so long as the invention remains operable. Moreover, two or more steps or actions can be conducted simultaneously.

The mention herein of any publication, for example, in the Background section, is not an admission that the publication serves as prior art with respect to any of the claims presented herein. The Background section is presented for purposes of clarity and is not meant as a description of prior art with respect to any claim.

Described herein are systems and methods that can be used for multiplexed and parallel detection of various biomarkers in a biological sample for diagnosis, prognosis and therapeutic use. For example, the present disclosure can be used to monitor and/or optimize treatment (e.g., for Assisted Reproductive Technology (ART)), evaluate the status of multiple biomarkers (e.g., estradiol (E2), progesterone (P4)), and determine progression and prognosis. Systems and methods including detectors, microfluidics, and bioassays can be used for point-of-care (POC) testing to improve the quality of care for patients with various diseases, lower cost, and improve patient comfort.

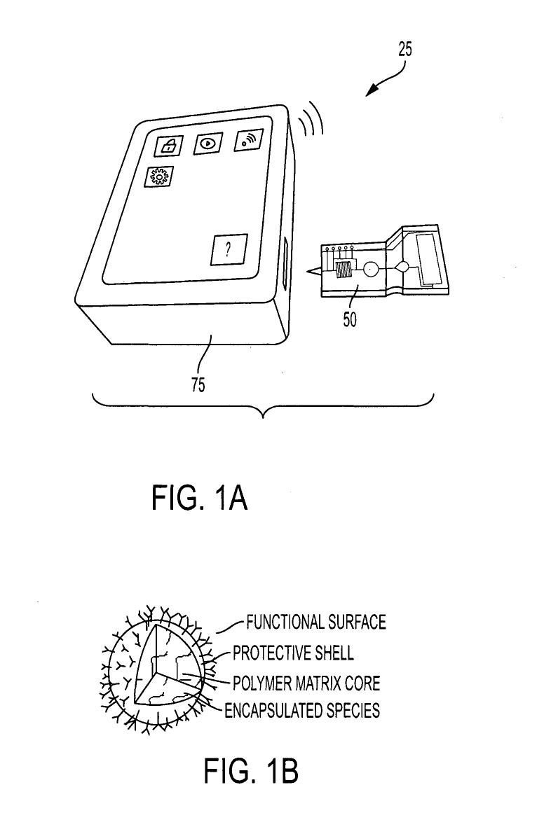

A rendering of the example testing devices described herein is shown in FIG. 1A. In some cases, the patient can prick her finger and draw the blood into a single-use testing cartridge. This action can be performed at home or in a clinic waiting room. The patient (or nurse) can then place the cartridge in a reader, enter verification information, and start the test. In some embodiments, the device can wirelessly upload the encrypted test results to a cloud database that allows the patient's doctor to review the results and provide the patient with gonadotropin dosing information. The workflow maximizes ease-of-use and minimizes device cost while ensuring the doctor can interpret the data and, if necessary, request the patient to perform another test. This workflow is compliant with privacy regulations, such as HIPAA. Devices can be owned (or leased) and maintained by clinics, who can provide the devices and cartridges to patients during Controlled Ovarian Hyperstimulation (COH) periods.

Exemplary engineered nanoparticle (eNPs), or enzyme-replacement technology, suitable for the present disclosure are described in U.S. Application No. 62/142,721, filed on Apr. 3, 2015, the content of which is incorporated by reference in its entirety. eNP technology provides pregnancy test-like stability and central-lab sensitivity to assays requiring signal amplification and precise quantification. Traditional enzyme-free amplification strategies have been limited by performance issues that lower their sensitivities below that required for many biomarkers, including fertility hormones. In contrast, the present disclosure describes combination of nanoparticle formulation techniques and optical detection hardware with a microfluidic platform to create an easy-to-use POC device. To this end, the present disclosure describes that this combination is capable of achieving clinical lab-quality hormone level measurements from a finger-prick blood sample, which have similar E2 levels to venipuncture samples. The eNPs encapsulate a reactive core within a protective shell, as illustrated in FIG. 1B. This design allows the core to be shielded during the antibody binding steps of the assay. At the start of the subsequent signal development stage, a specific trigger is applied to burst the eNPs and release the core contents, which then catalyze the signal-generating reaction. The encapsulation of the signal-generating species in a nanoparticle provides four advances over traditional immunoassays:

(i) Stability required for repeatable POC assays. The eNPs are shelf storage-stable by encapsulating thermally-insensitive small molecule and inorganic catalysts in an inert shell. This stability enables accurate quantification of samples in the field;

(ii) Multiplexing: parallel detection of multiple analytes from a single reaction volume. The use of different catalysts and/or triggers in eNPs functionalized to bind different analytes enables simultaneous quantification of complete biomarker datasets from small samples;

(iii) Enhanced sensitivity. A nanoparticle of ˜100 nm diameter, a size commonly used for antibody binding, would be capable of holding greater than 10³ small molecule catalysts (e.g., iron terra amido macrocyclic ligand or Fe-TAML) each 1/100^{th} of the size and ½ to 1/10^{th} of the activity of horseradish peroxidase (HRP) enzymes, the most common type used for ELISAs. In contrast, about 1-5 traditional HRP labels are labeled per antibody. Moreover, nanoparticle functionalization with multiple groups markedly increases avidity, enhancing sensitivity; and

(iv) Potential to reduce cost. A POC platform needs to give accurate readings for multiple hormones reproducibly from small, whole blood samples to be of clinical utility. Moreover, POC testing is challenged by the need to reduce cost (e.g., manufacturing costs) while maintaining or improving detection thresholds of state-of-the art readers (e.g., fluorescence microplate readers such as Mol Dev).

### Nanoparticles

The nanoparticles for use in any of the assay methods described herein can be made of a suitable material such that the nanoparticles can be dissociated under, e.g., a chemical trigger. The suitable trigger for dissociating a particular nanoparticle would depend on the materials used for making the nanoparticle, which is within the knowledge of a skilled person in the art.

In some embodiments, the nanoparticle described herein can be in a single phase format which comprises a core structure and a functional surface. The core structure can be made of any suitable material(s) as known in the art or disclosed herein. A signal inducing agent as described herein is embedded or encapsulated in the core structure. The functional surface is for conjugating to a binding agent specific to an analyte of interest.

The core structure may comprise polymers, waxes, surfactants, and/or lipids. In some embodiments, the core structure can be made of natural and/or synthetic waxes, e.g., carnauba, beeswax, paraffin, microcrystalline, candle, siliconyl, Kester wax, candelilla, jojoba wax, or rice bran wax. Alternatively or in addition, the core structure may comprise fatty alcohols and fatty acids: cetyl alcohol, palmitoleyl alcohol, stearyl alcohol, nonadecyl alcohol, heptadecyl alcohol, propionic acid, butyric acid, valeric acid, caproic acid, enanthic acid, caprylic acid, pelargonic acid, capric acid, undecylic acid, lauric acid, tridecylic acid, myristic acid, pentadecylic acid, palmitic acid, margaric acid, stearic acid, nonadecylic acid, linolenic acid, stearidonic acid, linoleic acid, palmitoleic acid, oleic acid, or a combination thereof. In other embodiments, the core structure may comprise nondegradable polymers (e.g., polystyrene, novolac, poly vinyl acetate, poly methyl methacrylate, poly vinyl pyrrole, poly vinyl acetate, polyisoprene, polybutadiene) and/or degradable polymers (e.g., PLGA, PLA, poly-ε-caprolactone).

In some embodiments, the core structure may comprise one or more inorganic compounds, which may form a matrix. The signal inducing agent can be embedded in the matrix. Example inorganic compounds for use in the present disclosure include, but are not limited to, iron oxide, cerium oxide, ruthenium oxide, copper oxide, copper, gold, silver, titanium dioxide, silicon, silicon nitride, tin oxide, carbon nanotubes, vanadium oxide, alumina, aluminum, cobalt oxide, platinum, palladium, zinc oxide, magnesium oxide, manganese oxide, nickel oxide.

In some embodiments, the core structure may be made of a material that can also serve as a signal inducing agent as described herein. Examples include a metal ion, a metal oxide, a metalorganic agent, a fluorophore, a chemiluminophore, and/or a photosensitizer.

In some embodiments, the core structure may comprise a dopant. A dopant is a trace element inserted into a substance in order to alter the chemical, thermal, optical, magnetic, and/or electrical properties of the substance. In the presence disclosure, a dopant is used to enhance the disassociation of the nanoparticles to release the signal inducing agent contained therein under a trigger, such as a physical trigger. The dopant may be a light-sensitive molecule, which was known in the art. Examples include diazonaphthoquinone (DNQ) and its derivatives, for example, esters of DNQ (as known in the area of photoresists). The dopant may also be a thermally-absorbing species, such as metallic nanoparticles (e.g., made of gold, silver, aluminum, nickel).

Any of the core structures described herein may also comprise one or more surfactants, including, but not limited to, Brij s, Spans, Tweens, Tritons, Igepals, Pluoronics, Poloxamers, lecithin, glyceryl monostearate, glyceryl monooleate, glyceryl monothioglycolate, glyceryl monocaprylate, glyceryl monolaurate, or a combination thereof.

The nanoparticle as described herein contains a functional outer surface which may coat the core structure directly or indirectly. The outer surface may comprise modified surfactant with functional surface and/or a mix of surfactant and surfactant with modified surface. Examples of the surfactants include, but are not limited to, Brijs, Spans, Tweens,

Tritons, Igepals, Pluoronics, Poloxamers, lecithin, glyceryl monostearate, glyceryl monooleate, glyceryl monothioglycolate, glyceryl monocaprylate, glyceryl monolaurate; functional surfaces may include amine, carboxylic acids, thiol, azides, alkynes, Ni, histidines, Cu, lysines, maleimide, NHS-ester, biotin, avidin, or a combination thereof.

In some embodiments, an intermediate agent is conjugated to the nanoparticle via the functional surface. The intermediate agent can bind to the binding agent either directly or indirectly. In one example, a biotin is conjugated to the functional surface of the nanoparticle as an intermediate agent. A biotin-conjugated binding agent can then be attached to the nanoparticle via a streptavidin.

In some embodiments, the nanoparticle may further comprise one or more stabilizing layers between the core structure and the functional outer surface. The stabilizing layer may comprise poly ethylene glycol (PEG) or a similar hydrophilic polymer-modified surface. Nanoparticle anchoring may occur with a hydrophobic region of the polymer forming a block-copolymer, which may be further designed to include a functional group at the end cap of the hydrophilic polymer. The layer may comprise an impermeable layer, alone or in combination with other layers of the nanoparticle, that may inhibit the release of the signal inducing agent from the nanoparticle to the environment before dissociation of the nanoparticle. The stabilizing layers may be applied deterministically or may self-assemble.

The nanoparticle can be in a matrix format, in which the transition-metal catalyst is embedded or entrapped. Alternatively, the nanoparticle may be in a core-shell format, in which the signal inducing agent is encapsulated. For example, any of the core structure described herein containing one or more signal inducing agents may be coated with a layer (a capping layer), which can be made of the same polymer material(s) as the core structure. The outer functional surface as described herein is added on top of the capping layer. Such a nanoparticle can further comprise one or more stabilizing layer as described herein between the capping layer and the outer surface.

In some embodiments, the nanoparticle can be in a liposome format, which comprises an outside lipid membrane encapsulating a signal inducing agent (e.g., a non-enzyme or non-protein molecule). In some embodiments, the nanoparticle is free of any liquid phase (e.g., solid nanoparticles). In other embodiments, the nanoparticle can comprise a hollow core that contains air or liquid. Such a nanoparticle may be dissociated by ultrasound.

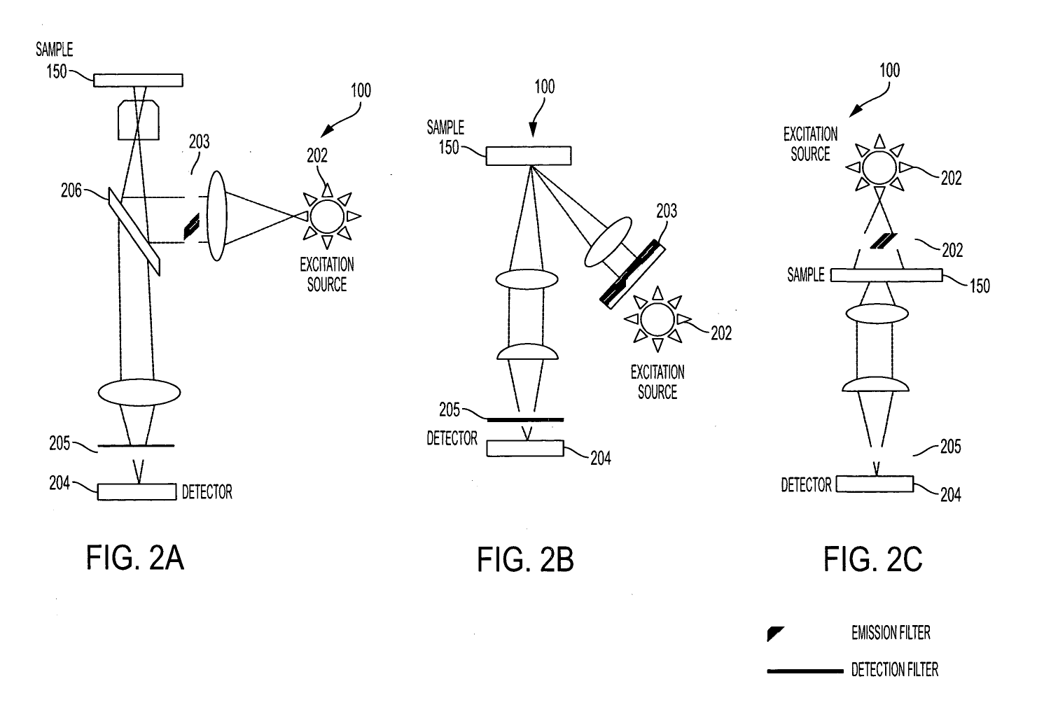

The optical system may consist of various optical components such as lenses, optical fibers, gratings, etc., used to increase photon collection efficiency and minimize stray light. Appropriate emission and excitation filters may be used to minimize stray light. FIGS. 2A-2C shows three possible example configurations of excitation source, detector, and appropriate optical elements.

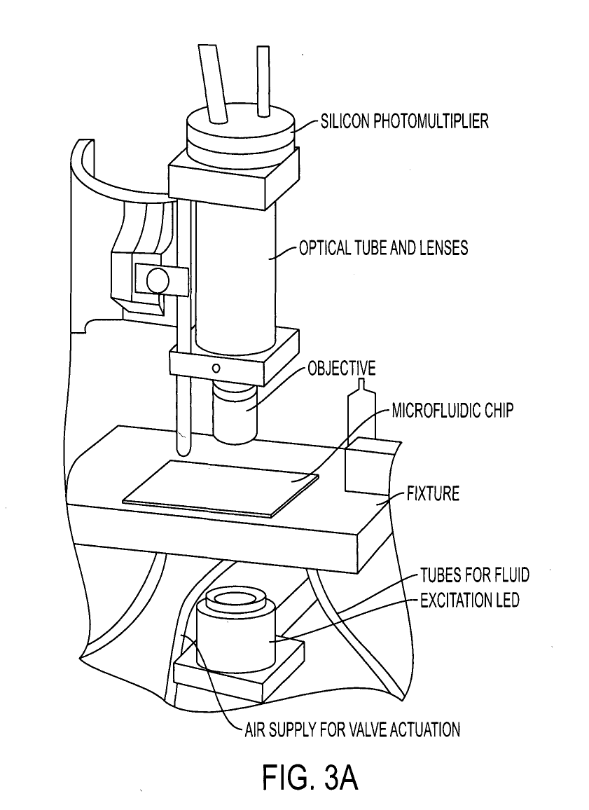

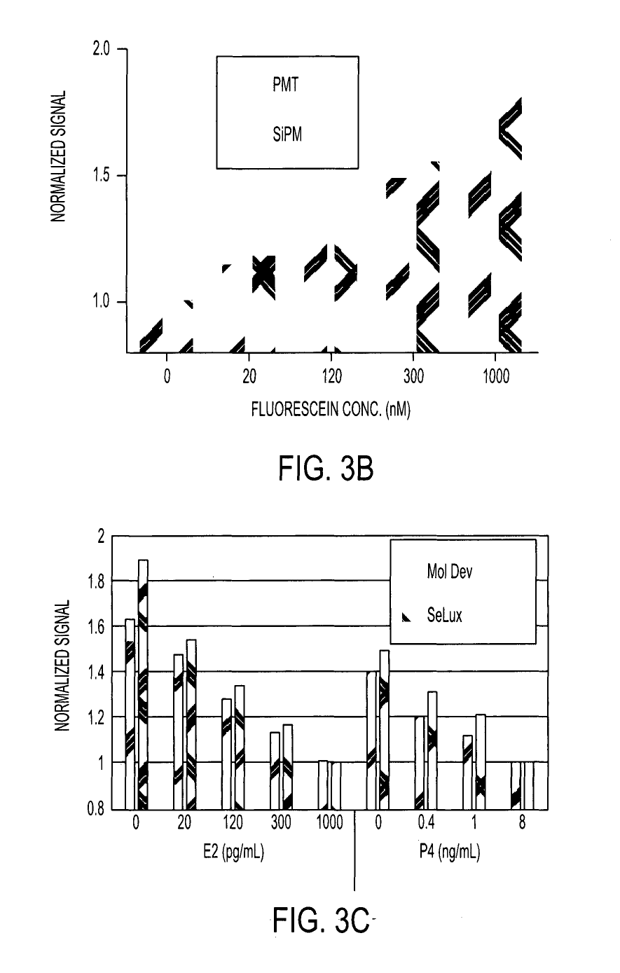

As described herein, optical signals generated by eNPS are compatible with low cost, plastic disposable microfluidic cartridges (e.g., wherein the cartridge can be free of detection electronics and active fluidic components) containing assay reagents. Further, the optical detector disclosed herein comprise of less than $4,000 total component parts and has shown to be capable of achieving precise eNP-based E2 and P4 quantification (SeLux) comparable to a state-of-the-art fluorescence microplate reader (Mol Dev) as shown in FIGS. 3A-C. Moreover, eNPs are simple to manufacture with existing protocols. These considerations avoid system and manufacturing complexities that limit conventional POC devices.

In some embodiments, the platform described herein can be for applications outside of ART. For example, the POC platform can be used for applications in cancer and/or oncology and dialysis. Details regarding applications in dialysis are described, for example, in U.S. Provisional Application No. 62/174,957, filed on Jun. 12, 2015 and entitled “Parallel Detection of Biomarkers and Uses Thereof,” the content of which is incorporated by reference in its entirety.

While the reader devices described herein have been substantially described as being used in conjunction with the microfluidic cartridges described herein, other implementations are possible. For example, in some embodiments, the reader devices described herein can be configured to analyze traditional microtiter plates or cuvettes. For example, some systems can include a solid-state photomultiplier (e.g., a silicon photomultiplier) detector or detector arrays configured in 8×1 or 12×1 or 8×12 arrays with appropriate optical elements for additional focusing and mechanical elements for plate movement, alignment, and positioning.

### Assay Methods

The nanoparticles described herein may be used with multiple chemical and/or biochemical assay formats and/or platforms including, but not limited to, well-, microwell-, microfluidic-, gel-, magnetic particle-, solid chromatographic-based assay formats, for detecting and quantifying analytes of interest in a sample. Assay types may include, but are not limited to, sandwich, hybridization, competition, and other assays.

Depending upon the type of the signal inducing agent used in the nanoparticles, the assay method can be a one-tier amplification assay or a two-tier amplification assay.

Examples include the release of specific ions that can be electrically or optically detected including, but not limited to, F⁻, Cu⁺, Cu²⁺, Fe²⁺, Fe³⁺, NO₃⁻, SO₄²⁺, NH₄⁺, Hg₂⁺, Ti²⁺, Ti⁴⁺, S⁻, Ca²⁺, H⁺, Au²⁺, Ag⁺, Pt²⁺, etc. In order to enhance optical detection, ions can complex with species in the solution, such as the aqueous cupric ammonium ion.

The signal inducing agent may also participate in one or more reactions that produce one or more measurable signals. The signals may be optical, electrical, magnetic, acoustic, or other. The payloads may be reagents or catalysts in the reaction(s) that produce the signals, with catalysis the preferred mode of operation. They may be molecular, ionic, or particulate in nature. The signal inducing agent may result in a reaction that either increases or decreases the measured signal. Examples of reactions include, but are not limited to, oxidation, reduction, addition, elimination, polymerization, and/or rearrangement chemistries. The signal amplification may thus be two-fold or “two-tier”: the first level is based on the ratio of the number of payload species to binding events and the second level is based on the reaction(s) in which the payload species participate.

Nanoparticles with signal inducing agents that produce two-tier amplification may require reagents to be added to the sample being tested. These reagents may be added before, during, or after the biochemical binding event(s). In order to control the timing of the onset of the reaction, one or more reagents may be contained in an inactive state, such as protected in a particle or polymer, until the onset of a defined trigger. Suitable triggers are the same as those that release signal inducing agents. Such “reagent vessels” may contain surface molecules that participate in the biochemical binding event(s). They may also contain magnetic particles to enable magnetically-driven assay control.

Multiple assays may be run in parallel and/or serially. Control assays may validate assay performance and/or provide and/or enhance quantification. Species other than the “detection species,” termed “tracers,” may be present for these controls.

Assay and/or particle design may also enable multiplexed detection to be performed. Labels may respond to similar or different triggers, may contain similar or different payloads, and/or may contain similar or different tracers. For bead-based assays, tracers may be present on beads that participate in the assays. Tracers may be used to tune the number of labels available.

Microfluidic assays may be performed on a cartridge designed to spin. Such centrifugal forces may be used to drive fluid flow and/or contain reactions. The spin speed may be used to control the assays, isolating reactions and determining reaction times. Such fluid control may be defined by elements like, but not limited to, flow time through microfluidic paths, soluble plugs with defined dissolution times, plugs that open with sufficient pressure, etc.

### Example

An inorganic catalyst, titania nanoparticles (TNPs), was used to perform the oxidation reaction to generate an optical signal. The TNPs provide robustness and optical control over the oxidation reaction. When UV light (λ˜254 nm) irradiates the TNPs, an electron-hole pair can be generated. When the hole migrates to the semiconductor surface, the hole can be annihilated by an electron removed from an organic species in close proximity and oxidizes the organic molecule. In order to maximize reaction rates, ˜8 nm, W-doped TNPs (W-TNPs) were used as described herein.

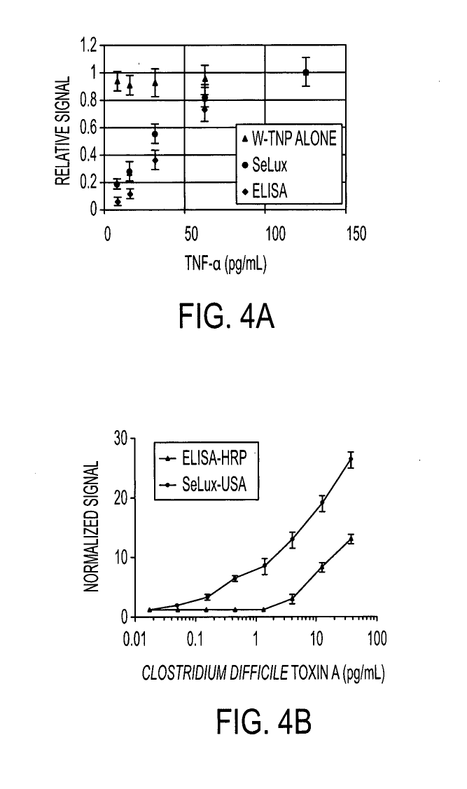

The encapsulation of W-TNPs in eNPs enabled high sensitivity detection (FIG. 3). As shown in FIG. 4A, the ability to detect low-pg/mL concentrations of TNF-α in spiked buffer samples using antibodies directly modified with W-TNPs (W-TNP Alone) and antibodies modified with eNPs containing W-TNPs (SeLux) were compared. The eNPs demonstrated similar sensitivity and dynamic range to the ELISA control, which used HRP. In contrast, directly coupled W-TNPs were not able to amplify the signal. The improved signal provided by the eNP technology is at least due to the about 110-fold more W-TNPs present in eNPs per antibody binding event. The difference in relative ELISA- and eNP-derived signals can be due to the ability of eNPs to bind multiple surface sites due to their size.

Additional increase in limit of detection of an immunoassay can be achieved by using Fe-TAML derivative loaded eNPs. The packing density and catalytic activity of TAML enables 100-fold higher signal generation per binding event compared to HRP. The limit of detection of SeLux assay using eNP is approximately 100 fold higher than the traditional HRP ELISA as shown in FIG. 4B.

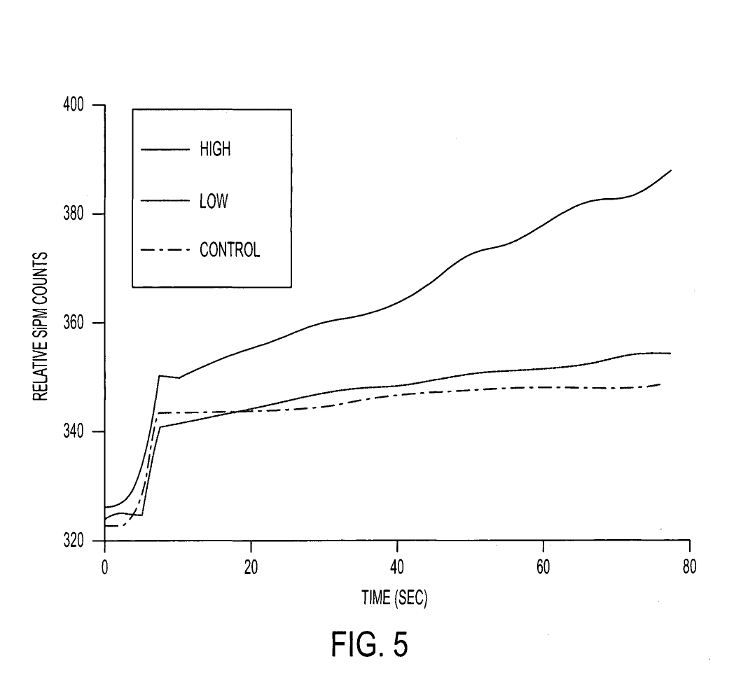

FIG. 5 Demonstrates detection of DNA of L. Monocytogenes on a microfluidic cartridge using SeLux device from “complex media,” comprised of L. monocytogenes bacteria added to lettuce homogenates. Low signal corresponds to ˜20 colony forming units (CFUs) while High signal corresponds to ˜100 CFUs.

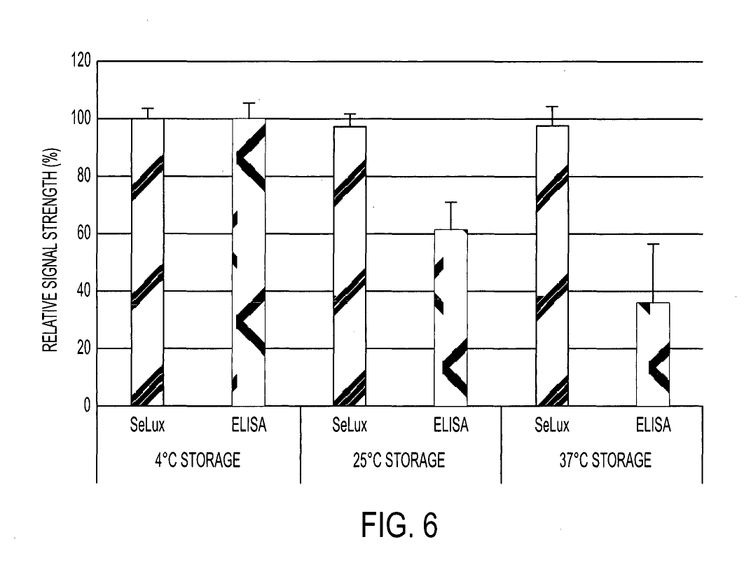

The stability of eNPs under different storage conditions enables an assay to be performed at the point of care. The performance of the SeLux and ELISA reagents were compared after storage for 6 weeks at 4° C., 6 weeks at 25° C., or 4 weeks at 4° C. followed by 2 weeks at 37° C., for accelerated lifetime testing. As shown in FIG. 6, eNP signal generation remains within 98% of its 4° C. storage performance. In contrast, HRP suffers significant degradation and increased variability.

### Differential Photosensitization

TNP doping can be tuned to produce electron-hole pairs upon visible light adsorption through surface functionalization with organic dyes. Such functionalization enables nanoparticle populations, each with a different dye, to drive oxidation reactions in response to the absorption of light of a specific wavelength. This scheme requires that the bandgap of the TNPs be reduced sufficiently to enable visible light to create an electron-hole pair, which can be achieved through the inclusion of dopants, such as nitrogen or iron, without diminishing generation efficiency. The TNP doping must be tuned to match the dye energy levels for optimal electron transfer. Since the electron-hole generation efficiency of TNPs is dominated by surface defects, the nanoparticle-dye interface can be optimized. Dye functionalization of the TNP surface by adsorption and covalent attachment, both well-developed techniques can also be optimized. In some embodiments, dye adsorption enables TNP surface functionalization only with organic groups, such as fluorine or sulfate, specifically designed to enhance electron-hole generation. In some embodiments, covalent modification can enhance electron transport through proximity effects and a more stable bond.

### Thermal Engineering

As an alternative to wavelength-based multiplexing, eNPs can be designed to have different release conditions. In this system, all nanoparticles would be doped with the same TNPs but, for example, the nanoparticles designed to detect E2 and those for P4 would release their contents at different temperatures. This can be achieved by using nanoparticle matrix materials with different melting points for the different particle type. Glycerides and waxes are particularly well-suited to this approach because of their ready availability in tight, 2-3° C. melting-point bands with 7-10° C. separation. Alternative catalysts can also be considered as multiplexing strategies. Nanoparticles of iron, cesium, and zinc oxides have recently been demonstrated to have sufficiently high catalytic activity for use as core reactants in eNP nanoparticle design. In contrast, higher packing densities can be achieved with metalorganic catalysts.

### Detection Signal Selection

The payload of eNPs can determine or otherwise influence the desired method for signal generation. Formulations can use a microfluidizer or high-pressure homogenizer to generate the eNPs from oil-in-water and oil-in-oil emulsions. The resulting particles can be purified with tangential flow filtration. This process flow provides rapid eNP optimization due to its flexibility and speed. The eNPs can be optimized for surface chemistry and loading, while maintaining a tight polydispersity. These features contribute to the working range of the assay and its reproducibility. PEGylated nanoparticles that display functional groups for binding can be used. In order to vary the concentration of functional groups, a mixture of PEG-alone and PEG-functional groups can be included. The loading eNP governs sensitivity, speed, and the assay's working range.

### EXAMPLE DEVICES

### Microfluidic Platform Design

Any of various systems and devices can be implemented to carry out the testing and diagnostic methods described herein. In some examples, referring to FIG. 1A, a system 25 to carry out the methods described herein can include a cartridge device (e.g., a microfluidic chip) 50 to receive and process a patient sample and a reader device (e.g., detection hardware) 75 to interface with the cartridge device to analyze the processed sample. As mentioned above, a user (e.g., a patient) can obtain a sample to input into the cartridge, for example by pricking a finger and drawing blood into the cartridge. The cartridge 50 can then be placed into the reader 75, and the test can be performed. In some embodiments, the reader 75 can wirelessly upload test results or other patient information to a cloud database so that is can be reviewed by a doctor. As described herein, the microfluidic platform system design focuses on two major hardware components, the microfluidic platform and the detection hardware. The microfluidic platform can be optimized for assay performance of the multiplexed system and the optimal signal amplification strategy can be determined based on signal type (e.g., fluorescence, absorbance, luminescence, chemiluminescence, etc.).

The cartridge can have various modules to perform different fluid processing steps in order to prepare a sample for testing. For example, a fluidic cartridge can accept a sample and carry out processing steps to prepare the sample for testing, such as filtration, dilution, separation, etc. The prepared sample can then be incubated with a capture probe that is pre-spotted. For competitive assays, detector-signal generating species conjugates can be mixed with sample prior to the sample reaching assay zone. In a case of sandwich assays, detector-signal generating species conjugates can be incubated in the assay zone together with sample in order to lower the number of washing steps or the incubation may be performed sequentially. Upon incubation in the assay zone, a developer can be used to generate an optical signal.

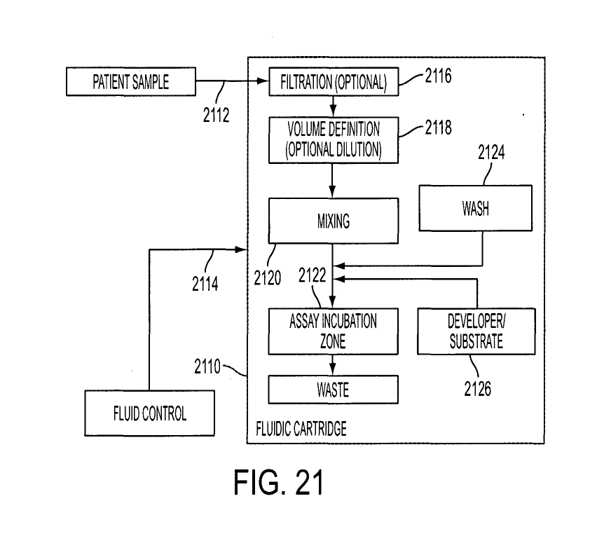

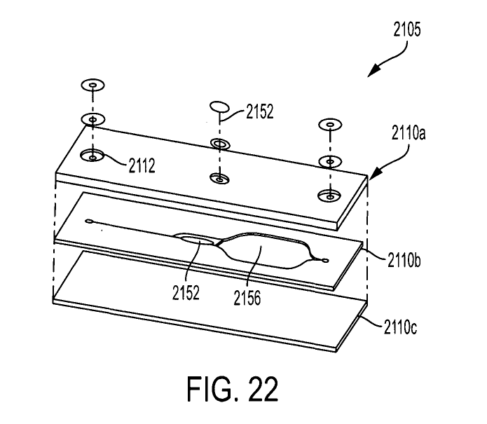

Thus referring to the schematic depiction of FIG. 21 and the exploded view of FIG. 22, a cartridge 2105 can include a base (e.g., chassis material) 2110a, an adhesive layer 2110b and a cover 2110c that can serve together as a frame for a sample input 2112 and a processing fluid input/manifold 2114. The cartridge 2105 includes several fluid processing modules, such as a filtration module 2116, a volume definition module 2118, a mixing module 2120, an assay incubation module 2122, one or more wash modules 2124, and a developer (or substrate) module 2126. Fluid can flow through the cartridge through one or more fluid passageways 2128 that fluidly connect the various inputs and modules for processing.

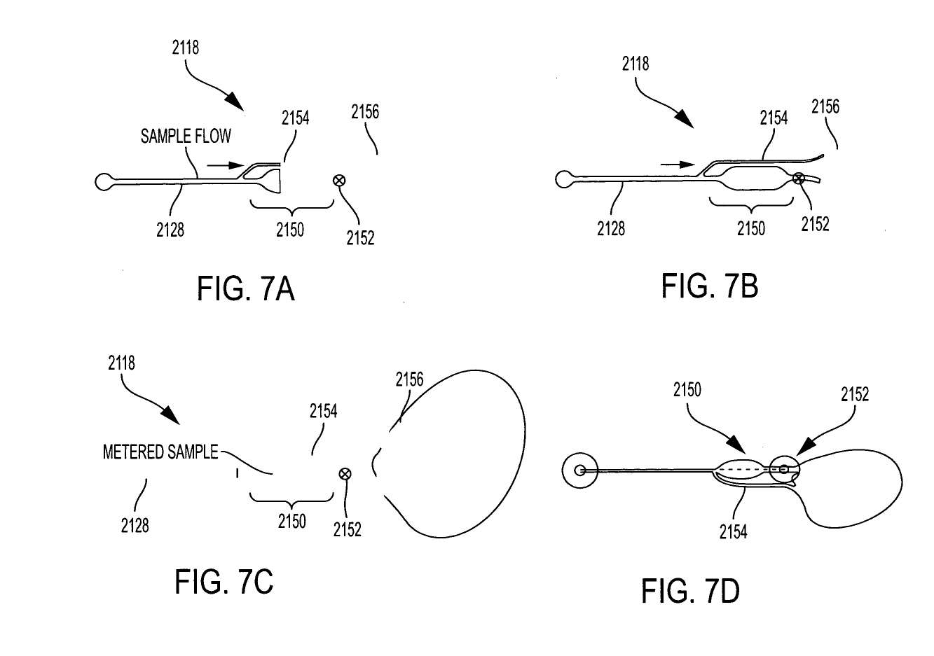

In some embodiments, the assay incubation module 2122, wash module 2128, developer module 2126 can be performed in a single module with a single chamber, for example, that described in FIG. 7, wherein all fluids can be introduced off-chip.

Throughout the cartridge and fluid passageways 2128, fluid can be transferred by generating positive and/or negative pressure.

In some embodiments, samples can be transferred to a cartridge directly from patient (e.g., via a pin prick), pipette or collection container (e.g., vacutainer).

The filtration module 2116 can be implemented to achieve any of various sample filtration or separation processes. For example, a patient sample can include various combinations of fluid, such as whole blood, plasma, saliva, urine, cerebrospinal fluid, or a swab sample diluted in appropriated solution (e.g., saline). In some embodiments, it can be desirable to separate certain components of the sample. For example, in some cases, the use of whole blood without any processing can be detrimental for precision and accuracy of certain biological assays. Therefore, filtration can be useful to separate relevant markers from larger species, such as blood filtration to separate plasma from red and white blood cells. Filtration is typically achieved via size exclusion using, for example, a filter membrane, an etched or machined pillar array, etc.

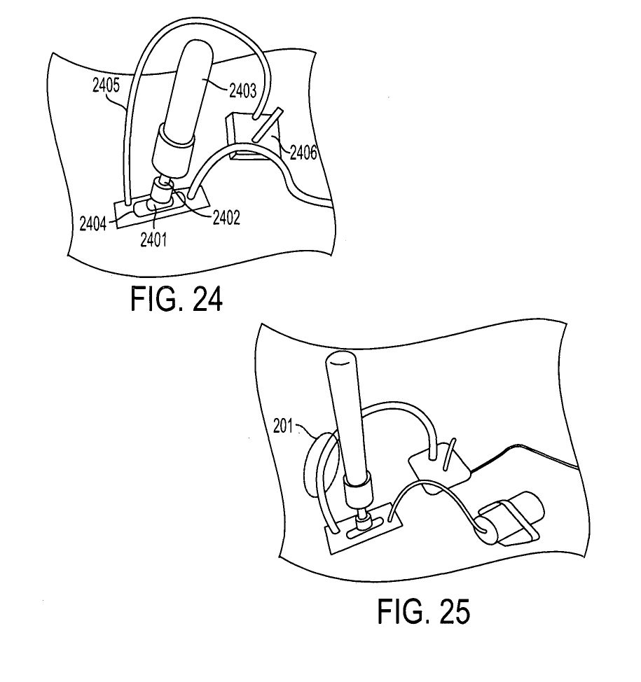

An example filtration system is depicted in FIGS. 24 and 25. Specifically, FIGS. 24 and 25 illustrate an integrated blood filtration device with an interface to a blood-containing vessel (e.g., vacutainer) capable of filtering blood to plasma. Using a pump, such as a computer-controlled diaphragm micro-pump (e.g., a diaphragm pump manufactured by Takasago) or a peristaltic pump, and a solenoid valve in a tuned time sequence and controlled flow, up to 40 microliters (μl) of plasma starting from 120 microliters of whole blood can be extracted. Similarly for a smaller sized device, 15 μl of plasma from a few drops of blood (e.g., approximately 40-50 μl) can be extracted. In some embodiments, starting from 20 to 250 microliters of whole blood (e.g., from 30 to 175 microliters, e.g., from 40 to 150 microliters), an amount of plasma is extracted, e.g., at least 20% of the total volume of the sample is extracted as plasma volume, e.g., at least 25%, e.g., at least 30%, e.g., at least 35%. The device can be compatible with microfluidic manufacturing techniques and can be integrated with chips capable of performing biological assays. Materials of the device can include, but are not limited to the following: poly(methyl methacrylate) (PMMA), polystyrene (PS), polycarbonate (PC), cyclic olefin copolymer (COC)/cyclic olefin polymer (COP), polyethylene terephthalate (PET), or any of various thermoplastic.

FIG. 24 illustrates an example filter and shows a filter membrane 2401 that is encased within a microfluidic device (e.g., a microfluidic cartridge) and a needle 2402 capable of piercing the septum of a blood or urine collection container 2403. Fluid (e.g., a sample) contained within the blood or urine collection container enters a chamber 2404 via the membrane 2401 and is filtered such that only plasma enters the exit port 2105 when drawn by a pump 2406. In some embodiments, the filter membrane 2401 can be disposed in, or be a part of, the needle 2402 (e.g., such that the membrane couples with the microfluidic cartridge) and is external to the microfluidic cartridge. For example, in some embodiments, the membrane 2401 can disposed in an extraction channel of the microfluidic cartridge. In some embodiments, the extraction channel can be positioned substantially perpendicular to a flow path for a whole blood flow. For example, a syringe-filter can connect to the cartridge for extracting plasma from a blood sample. In some embodiments, the extraction channel can include at least one port (e.g., two ports), where one of the ports is exposed to air and can be controlled by a valve and the other port can serve for extraction from the channel. For example, the port that serves for extraction can be fluidly coupled to the rest of the microfluidic cartridge to provide a sample for processing.

In some cases, filter integration into a microfluidic solid-phase assay (e.g., immunoassay, hybridization assay) can help simplify a system such that a sample (e.g., a blood or urine sample) contained in a suitable collection tube can directly interface with the microfluidic cartridge. In some embodiments, the filter membrane can have a surface area from about 25 mm² to 500 mm².

FIG. 25 shows a blood separation device shown in FIG. 24 after plasma has been drawn up an exit port, shown highlighted in a dashed oval (201). For example, pressure can be applied using the pump 2406 which draws fluid from the container 2403 (e.g., blood in this example) through the membrane filter 2401 and plasma within the blood can be separated.

In some embodiments, fluid can be driven through the filtration module via hydrostatic pressure formed by fluid height in the vacutainer. Using external pump and valve filtered sample (e.g. plasma) is extracted without lysis of cells (e.g., red and white blood cells). Extraction efficiency can reach 80% for certain type of membranes (e.g., Pall Corporation Vivid membrane).

The volume definition module 2118 can include a chamber (e.g., a metering chamber) that can serve as a detection zone and/or an assay zone. Alternatively, in some cases, the cartridge can include a separate detection zone and assay zone. In some embodiments, volume definition, assay incubation, and detection can be performed in the chamber.

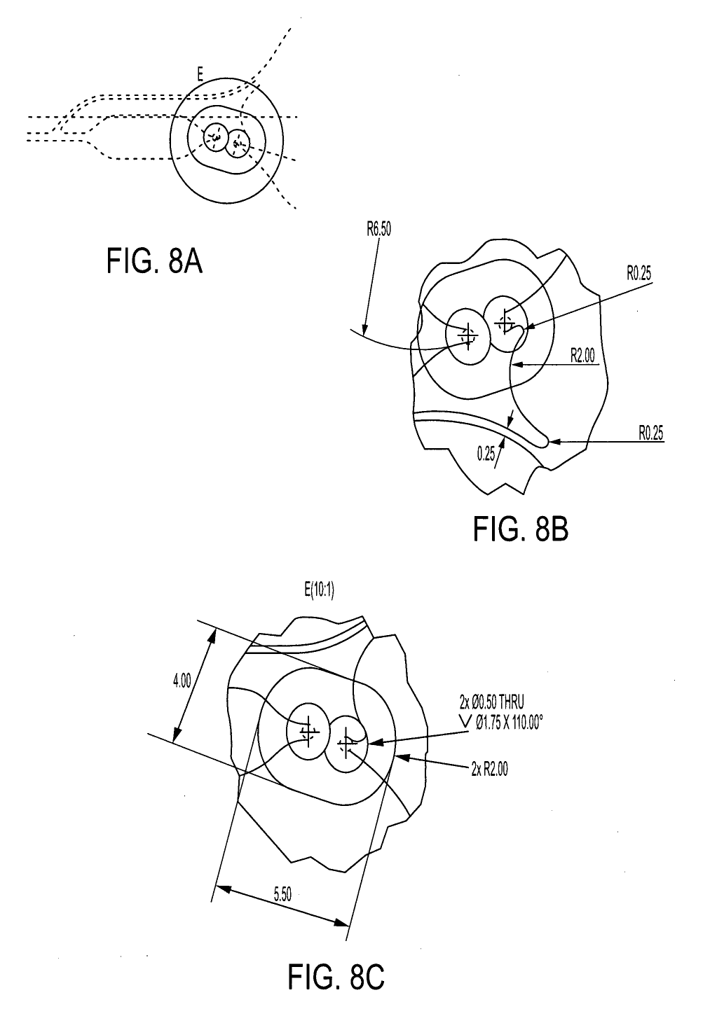

In some embodiments, it can be beneficial to define a precise volume of the sample within the chamber. Accurate volume metering can be useful to achieve a low coefficient of variation (CV). In some of the examples described herein, accurate volume metering can be achieved using a volume defining chamber, an overflow channel, and a valve fluidly coupled to the volume defining chamber. The use of a metering chamber with an overflow enables all fluid volumes to be measured using the same component, allowing simpler chip design with minimal number of active components. The volume defining chamber can be part of the volume definition module 2118. Briefly referring to FIGS. 7A-7D and 8A-8C, a volume definition module 2118 can include a volume defining chamber (e.g., metering chamber) 2150, a fluid passageway 2128 to provide fluid defining chamber 2150, a valve (e.g., an exit valve) 2152 that can limit fluid from exiting the volume definition module 2118, and an overflow channel 2154. During use, as depicted in FIG. 7A, a sample to be processed can be delivered to the volume defining chamber 2150 where it will subsequently be processed. Once the volume defining chamber 2150 has been filled, as depicted in FIG. 7B, the valve 2152 can be closed, which limits the sample from further flowing into the volume defining chamber 2150.

With the valve closed, as depicted in FIG. 7C, with the sample being limited from flowing through the volume defining chamber 2150, the volume of the sample within the volume defining chamber 2150 can be maintained as additional sample is further limited from entering the chamber 2150. Rather than entering the chamber 2150, the closed valve 2152 causes additional flow to bypass the chamber 2150 and instead flow into the overflow channel 2154 and downstream to a waste reservoir 2156. For example, in some embodiments, when fluid is pumped into the chamber 2150 at predetermined speed (e.g., controlled by an external pump, such as a diaphragm pump), the valve 2152 can be closed in a timed fashion thus allowing the extra fluid to flow to the waste reservoir 2156. The flow rate through the overflow channel 2154 can be set to reduce (e.g., minimize) reagent waste with the valve 2152 closed and create preferential flow through the metering chamber 2150 with the valve 2152 open. The waste reservoir can be disposed on the cartridge as illustrated or off-chip. In some cases, keeping the waste on the cartridge can limit biohazard waste storage.

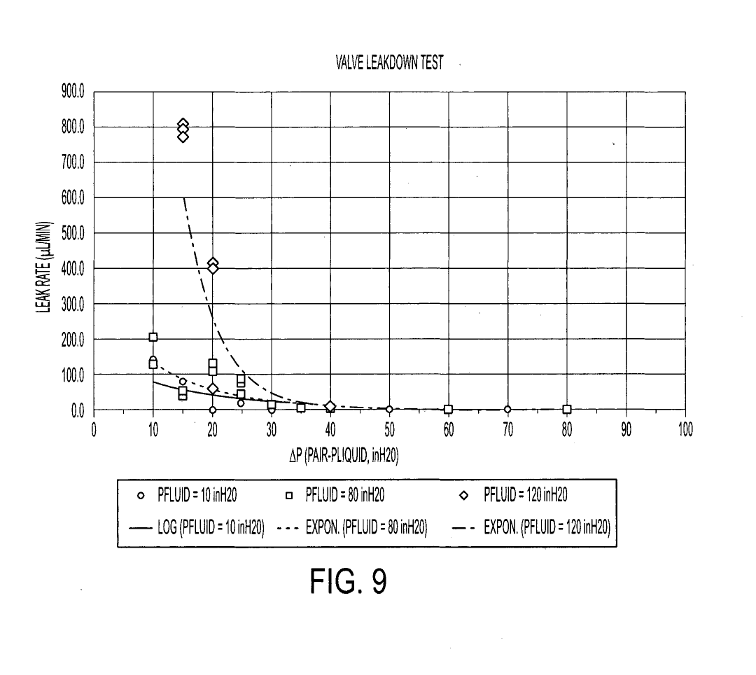

The valve 2152 can include any of various devices suitable to limit flow. For example, a valve (e.g., a pinch valve) can be designed and optimized to allow reliable operation at a wide range of pressure differentials. Valve actuation may be mechanical (e.g., using a plunger) or pneumatic (e.g., using pressurized air). In some embodiments, valve can be made of gas permeable material (e.g., nylon) wherein it can allow air to escape while blocking fluid flow. The valve design parameters, such as materials and cross-sectional size and shape can be optimized to allow specific range of operating pressures with limited (e.g., no) leakage. For example, FIG. 9 illustrates valve leakage test results for various pressure differentials tested. Such example metering chambers utilizing valves and overflow can be more useful than other conventional systems, such as those having a volume-defining unit with a channel that operates by centrifugal systems and capillary valves, because the mechanical valves (e.g., pinch) herein can typically be repeatedly used and operate at large pressure differentials. Whereas, capillary valve can typically only be used once since after being used for the first time they won't be as reliable since wetting angle will be different.

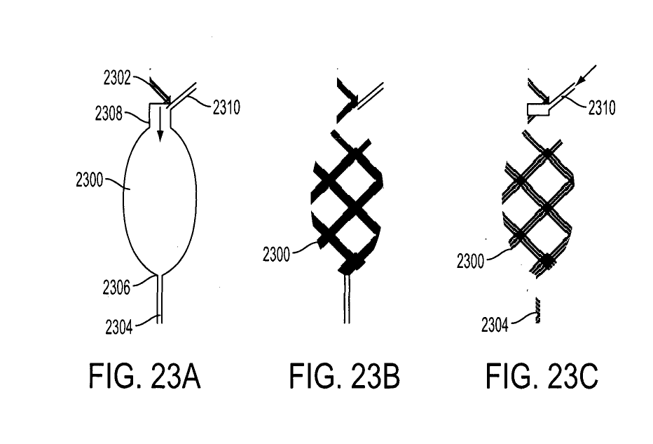

Other metering and valve embodiments are possible. For example, in some embodiments, in addition or alternatively to blocking flow from exiting the metering chamber, capillary valves can be used to control the volume of a flow through a chamber. In some embodiments, one or more metering chambers with predefined volumes can be filled. For example, referring to FIG. 23A, a metering chamber 2300 can include an inlet 2302, a capillary valve 2304 at an outlet 2306 of the metering chamber. The capillary valve can be used to define the volume of fluid in the chamber to allow for controlled fluid loading and extraction from the chamber. Specifically, additional gas can be introduced before an inlet 2308 of the chamber, for example, by a capillary air inlet 2310. Extraction of the fluid from the chamber can occur by using gas (e.g., air) though additional channels or ports exposed to air. FIG. 23A illustrates a fluid flowing into the chamber 2300. FIG. 23B illustrates the chamber 2300 being substantially filled with the fluid but not yet being expelled from the chamber via the capillary valve 2304. As depicted in FIG. 23C, gas can be introduced upstream from the chamber 2300 to drive fluid from the chamber and through the capillary valve 2304, thereby metering a volume of fluid within the chamber. In some cases, the fluid can be driven by a pressure drop at the outlet 2306. For example, the capillary air inlet 2310 may be open to ambient pressure and a downstream pressure drop can cause air to enter the capillary air inlet 2310 and thereby cause the fluid to exit the chamber.

In some embodiments, a sample can be diluted in the chamber. This may include dilution of sample in an assay buffer (e.g., phosphate buffer saline with or without detergents and blocking agents). The diluent may also contain a signal generating species (e.g., an enzyme, a chromophore, an engineered nanoparticle, etc.) conjugated to detector species (e.g., antibody in case of sandwich assays, antigens in case of competitive assays, or oligonucleotides, etc.). A ratiometric mixing process may be used to dilute sample by adjusting a ratio of cross-sectional area of a flow path (i.e., hydraulic analogy of resistance) of sample and diluent channels.

In some embodiments, the systems and methods herein can include diluting a sample in a diluent containing a known concentration of an optical tracer; and optically quantifying the tracer concentration after the dilution step, for example, such that the dilution factor can be optically verified during a sample binding stage of the assay.

Precise and accurate dilutions can be useful for biomarker assays, such as immunoassays and competitive immunoassays. For assays performed on microfluidic chips (e.g., microfluidic cartridges), mechanisms for precision metering can be designed into the microfluidic cartridge itself. However, these on-cartridge designs can utilize precise microfluidic dimensions, and thus, undesirably increase costs of microfluidic components.

As described herein, systems and methods providing optical feedback of dilution accuracy that occurs during a biomarker assay have been developed to ease the precision and accuracy requirements of microfluidic parts. Optical feedback of dilution accuracy can include a diluent that is used for sample dilution. The diluent can be spiked with a known concentration of soluble “tracer” dye or fluorophore. By measuring the tracer concentration after dilution and comparing it with the known and/or measured pre-dilution value, this approach allows the dilution factor to be verified optically during the sample binding stage of the immunoassay. Upon washing, the tracer can be removed and the sample can be returned to baseline.

This approach can also be used to provide optical feedback to determine the efficacy of washing. By monitoring the concentration of the tracer, washing can be determined to be “complete” after a specific threshold is reached.

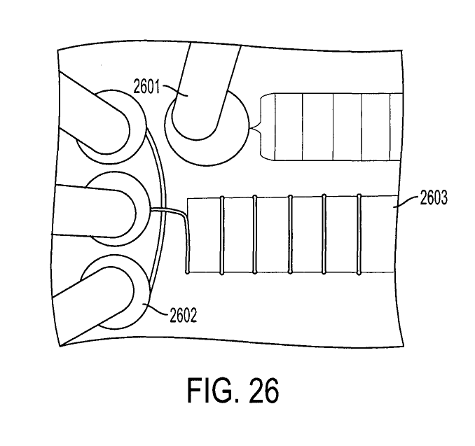

FIG. 26 shows an example dilution module with a 3D serpentine mixer to allow for efficient mixing. Theoretical dilution is 1:2 based on channel geometries. Blue colored tracer-containing solution 2601 (e.g., buffer or assay diluent) can be mixed with a yellow solution 2602 (e.g., patient sample) containing no tracers 2602 to produce a green solution 2603. Color is used for better visualization. Tracer solution is fluorescent with emission and excitation wavelengths that may be the same or different from the ones used during substrate addition (i.e., quantification). To determine right dilution factor fluorescent signal of the tracer can be measured in buffer (reference) and diluted sample (fraction of reference). Value equal to 1-fluorescence (diluted)/fluorescence (reference) represents sample dilution factor. In some embodiments, the cartridge can include another metering chamber that can be used before the main metering chamber 2150 in order to dilute the sample under test (e.g., whole blood, plasma, urine, etc.). As discussed above, dilution can be achieved by any of various techniques, for example, ratiometrically, such as by adjusting cross-sectional area of two merging channels.

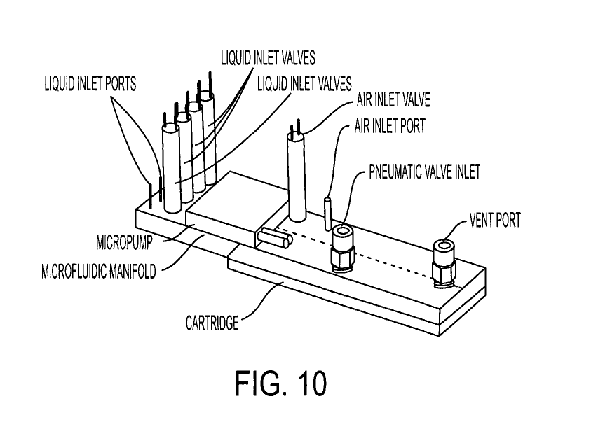

With a properly sized and diluted sample, the sample can then be incubated for certain time period to allow for interaction between the sample and reagent(s). For example, the assay zone, which can be the chamber, can be pre-spotted or lyophilized with a capture probe (e.g., antibody, oligonucleotide, nucleic acid, etc., or a magnetic bead with, e.g., antibody, oligonucleotide, nucleic acid, etc.). After incubation washing is performed to remove unbound species. Wash buffer can be added via one or more additional channels controlled via an off-chip or on-chip valves or manifold or through the same channel as other fluids, for example, in cases where an external manifold is used to selectively switch between fluids being provided to the various chambers, as depicted in FIG. 10. In some embodiments, multiple washes separated by an air gap may be used to improve washing efficiency.

In some cases, in addition or alternative to pre-spotting, a capture probe may be placed on magnetic particles. This allows for the capture, detector, and sample to be mixed at the same time, followed by a magnetic capture step in the assay zone, followed by one or more wash steps, and a developer (or substrate) addition.

In some embodiments, mixing of fluids is necessary (e.g., mixing of the blood sample and eNP conjugates, mixing of blood with HRP conjugates, etc.). A mixing serpentine that allows chaotic mixing can be utilized to provide equal opportunities for soluble biomarkers (e.g., hormones) and eNP conjugates to bind immobilized antibodies that were pre-spotted in the reaction zone. In the microfluidic geometry where flow is predominantly laminar and mixing is predominantly diffusion-based, this serpentine aids in mixing by reducing the mean free path length to reduce the time to mixing particles in the liquid. Optimization of spotted antibody concentrations and surface blocking strategies can be performed to ensure accuracy and repeatability. Washing can be performed by alternatively pulsing air and wash buffer to remove unbound eNPs as pulsed washes can offer significant improvements over continuous-fluid washes. Using advanced techniques for rapid prototyping, such as micro- and laser milling, microfluidic design iterations can occur within less than 2 weeks. Injection-molded manufactured designs help achieve less than $10 devices.

In some embodiments, the cartridge may be designed with few (e.g., without any) active components to further lower fabrication costs.

In some embodiments, detection can be performed on a microfluidic cartridge chip or in a cuvette after the sample has been run on a microfluidic chip (e.g., wherein the microfluidic chip serves as a lab-on-a-chip assay). Thus, in some embodiments, a microfluidic chip can lack a detection zone when detection is performed off the chip.

In some embodiments, the microfluidic chip can be used a single time. In some embodiments, wet reagents are stored in a separate cartridge and/or container and can be pumped into a microfluidics system. In some embodiments, a pump can be used to pull or push fluid through the cartridge. Selection between different reagents can be done using electrically or pneumatically actuated valves (e.g., solenoid pinch valves). In some embodiments, wet reagents can be replaced periodically, for example, in a week and/or month intervals based on the application. For example, the wet reagents can be replaced every 2 weeks (e.g., 1 cycle per patient) for IVF applications.

In some embodiments, the cartridge can be shaped and sized similar to that of a microscope slide, a credit card, a disc, or a disc cutout. Such design can allow for compact processing and storage.

### Detection Hardware Design

The detection hardware (e.g., the reader) can include various features to interface with the cartridge and perform the detection processes described herein. Specifically, the reader can include mechanical interfacing features, such as cartridge positioning features, valve operation components, or fluid processing features, and detection elements, such as an excitation source, optical sensors (e.g., detectors), and data processing electronics.

Primarily, as depicted in FIGS. 2A-2C, an example system can include a reader 100 having an excitation source 202 used to illuminate the sample 150, which can be contained in a cartridge. The reader 100 also typically includes a detector (e.g., or an array of detectors) 204 to analyze the illuminated sample. The reader 100 can also include filters, such as emission filters 203 to filter light provided by the excitation source 202 and/or detection filters 205 to filter lighter entering the detector 204. The excitation source 202 and detector 204 can be oriented in various configurations to illuminate the sample 150 with the excitation source 202 and observe the sample's reaction with the detector 204. Optical devices, such as lenses (e.g., condenser lenses), mirrors, etc., can be used to position the components in the different configurations. For example, as depicted in FIG. 2A, the detector 204 can be positioned across from, and in-line with, the sample 150, where the excitation source 202 can be positioned off to one side. A mirror 206 can be used to reflect the light from the excitation source 202 to the sample 150.

As depicted in FIG. 2B, in some embodiments, the excitation source 202 can be positioned to illuminate a surface of the sample 150 and the detector 204 can be positioned on the same side of the sample 150 as the excitation 202. Additionally or alternatively, referring to FIG. 2C, the excitation source 202 and detector 204 can be positioned on opposite sides of the sample 150.

The excitation light source 202 can include various components to generate light to illuminate the sample, as discussed herein. For example, the excitation source 202 can include a light emitting diode (LED) that generates incident light in a range from 250 nm to 1000 nm. The excitation light source 202 can be broad-spectrum (e.g., Xenon bulb) with appropriate emission filters 203 or narrow-band (e.g., laser diode) with or without emission filters 203 as necessary.

The detector or array of detectors 204 receives light emitted by at least one label that is bound to and/or released from the one or more binding agent/analyte complexes (e.g., released contents of eNP) within the sample to indicate the presence or compound being tested. In some embodiments, the detector can receive a light from a substrate solution chemically or physically modified by the label. For example, in some cases, a substrate can emit the light rather than label in case of chemiluminesce.

In some embodiments, the detector can include one or more silicon photomultipliers. In recent years, there have been developments in optical sensor technologies, such as ultrasensitive photodiodes with integrated low-noise amplifiers capable of detecting sub-pico-watt energies and SiPMs, which can replace conventional PMTs and work in either continuous or photon-counting modes, increasing design flexibility. SiPMs are 1-36 mm², $40-150 components and comprise an array of silicon avalanche photodiodes (APDs) operating at reverse bias of 20-100V in Geiger mode. However, these optical sensor technologies have not been incorporated into point of care devices and devices for application in immunology and nucleic acid detection. Low-cost SiPMs can be integrated with signal processing electronics and allow for the design of devices that do not sacrifice sensitivity for portability, size and cost.

In some embodiments, SiPMs of sizes between 1×1 mm² and 4×4 mm² with pixel sizes smaller than 50×50 mm² may have optimal characteristics for fluorescence measurement (e.g., low dark count versus high sensitivity and wide dynamic range).

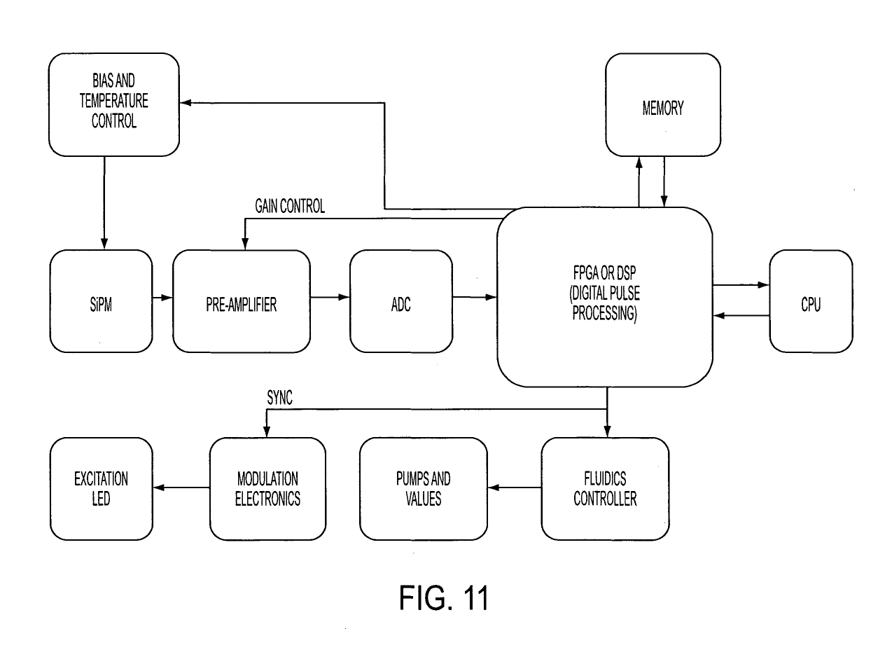

The system disclosed herein, for example, as shown as an exemplary prototype implementation in FIG. 3A, comprises a solid-state photomultiplier (e.g., an ultrasensitive silicon photomultiplier (SiPM)) enclosed in a housing with a circuit board to provide bias and connections to signal processing electronics and direct USB readout by a laptop. Condenser lenses allow additional focusing of collected photons. SiPM detector can be used with digital pulse processing techniques that are already developed for nuclear instrumentation and are in use in equipment such as scintillators and PET (Positron Emission Tomography) Scanners. Small size and operating voltage of SiPM (<100V) allows integration with electronic components on the same printed circuit board (PCB). Another example embodiment of a reader system is depicted in the schematic diagram of FIG. 11.

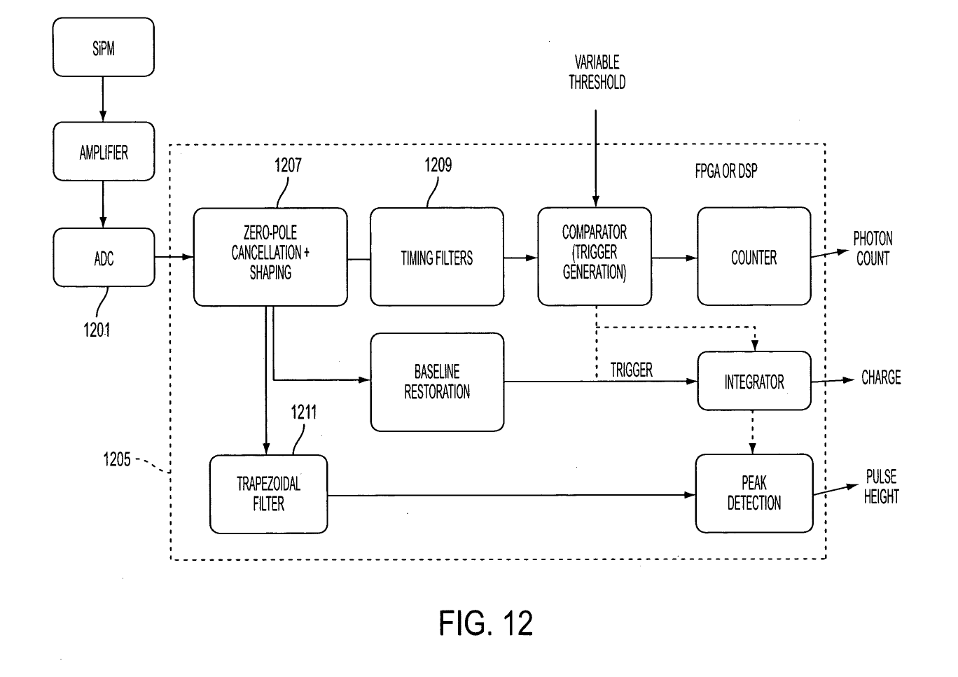

After detection, signal from a SiPM is amplified using a voltage or charge sensitive amplifier. The location of the amplifier is typically close to the detector (e.g., as close as possible to the detector) in order to reduce (e.g., minimize) noise. The signal can then be digitized, for example depicted in FIG. 12, using an analog to digital convertor 1201 that is chosen in concordance to pulse duration in order to capture all information about the pulse (peaking time, decay time, peak height). After digitization, pulse is processed digitally on a Field Programmable Gate Array (FPGA) or Digital Signal Processor (DSP) 1205 using techniques such as zero-pole cancellation and shaping filters 1207, timing filters 1209, trapezoidal filters 1211, etc. The digitized signal may be stored in memory which allows FPGA or DSP algorithm to access pulse data for post-processing.

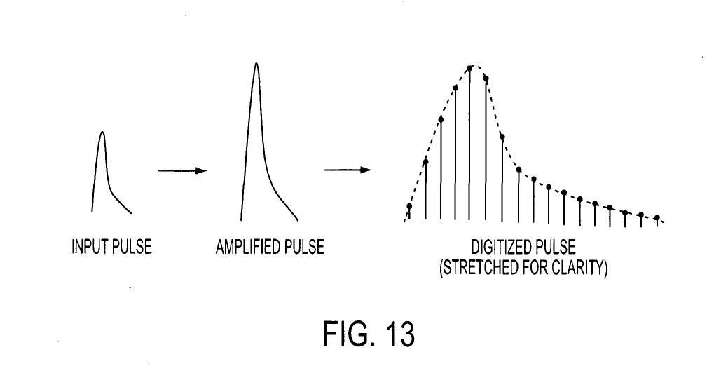

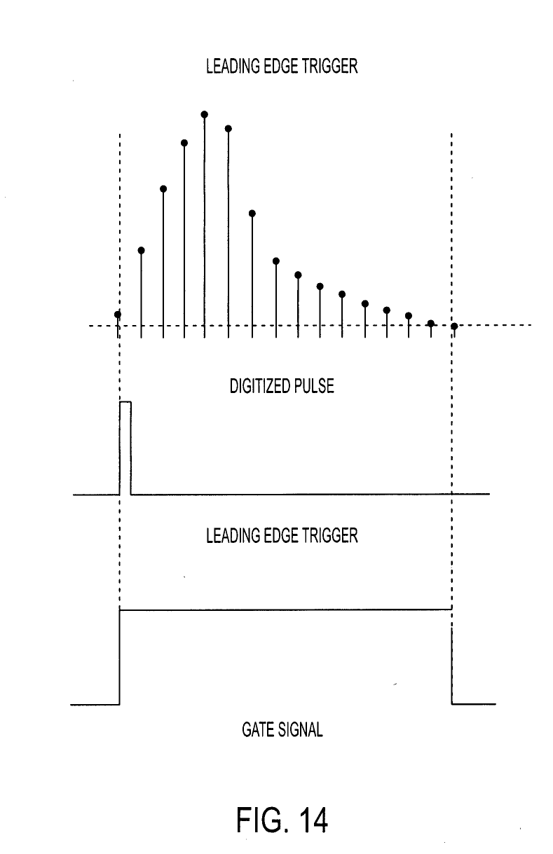

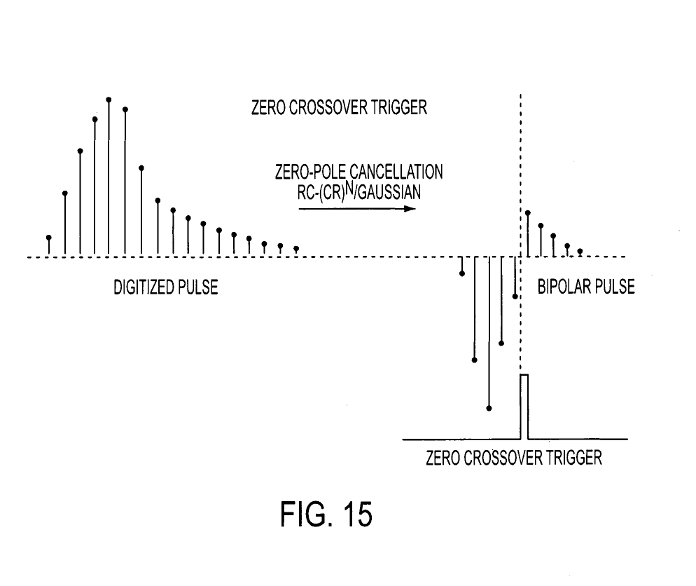

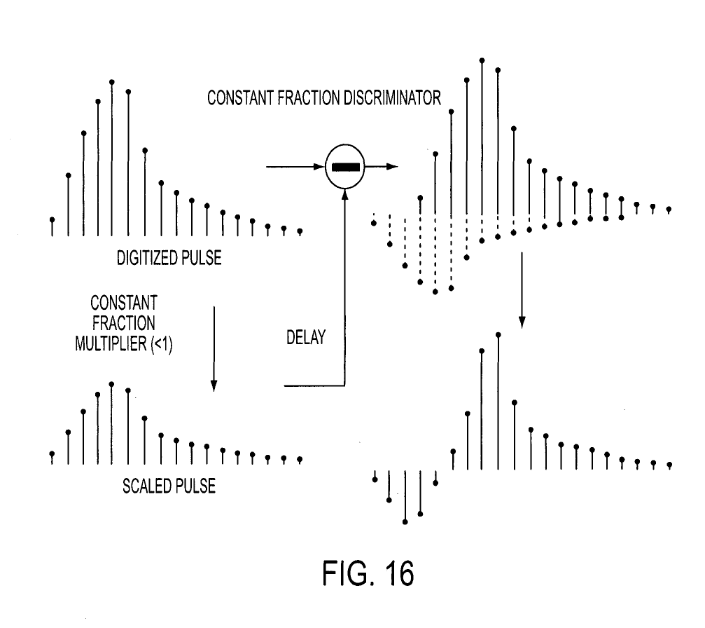

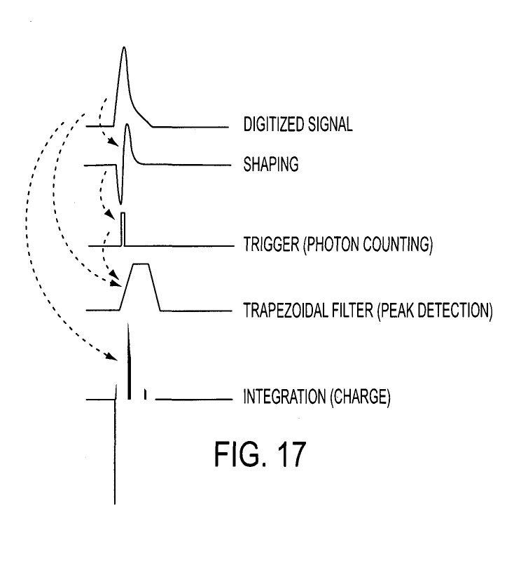

FIG. 12 shows an example of digital pulse processing via the FPGA or DSP 1205. In some embodiments, referring to FIG. 13, a digitized signal can be used to generate a trigger signal that can correspond to raising or falling edge or pulse maximum. One of the following three methods may be used: leading edge timing (depicted in FIG. 14), zero-cross over timing (depicted in FIG. 15), and constant fraction discriminator (depicted in FIG. 16). These various methods are depicted, for example, in FIGS. 14-16. Each of these methods has advantages and disadvantages ranging from easiness of algorithm implementation, noise sensitivity, etc. A variable threshold can be used to set trigger generation. The threshold may be adjusted by a user or automatically via an algorithm by using a figure of merit such as minimal dark pulse count (e.g., pulses generated via non-radiative source such as thermally generated carriers). Generated trigger may be directly used for photon counting. In some embodiments, signal may be filtered using trapezoidal filter whereas the output has a trapezoidal shape whose height is proportional to pulse height. Peak sensing algorithm may then be used to deduce pulse height and plot pulse height histogram. In some embodiments, a trigger signal may be used as a time stamp for pulse position in memory which may be digitally integrated to provide signal area (i.e., charge). Charge may then be used for charge histograms. Photon flux can be measured using frequency histograms of peak heights or charge (area below pulse). Peak heights or charge can be obtained as outputs of digital pulse processing algorithms shown in FIGS. 12 and 17.

As described herein, SiPMs provided improved performance over large, conventional, about $2 k photomultiplier tubes (PMTs) that require greater than 1 kV. In some embodiments, the detector comprises a SiPM with integrated amplification electronics, a photodiode, and filters and lenses. SiPM miniature detectors enabled the device described herein to perform E2 and P4 quantifications comparable to a state-of-the-art Molecular Devices microplate reader (FIG. 3C).

In one example (e.g., depicted in FIG. 3A), an SiPM (i.e., an S13360-3050CS model by Hamamatsu, 3 mm×3 mm chip and 50×50 micrometer pixels) was biased at the appropriate reverse voltage above the specified breakdown voltage. In the first prototype, the output from the SiPM was capacitively coupled to a signal processing hardware taken from SP5600 unit made by CAEN S.p.A. which provides a variable gain amplifier, a comparator with a variable threshold voltage, and a high-speed counter. Software was written for a National Instruments Data Acquisition Card to read data streams and generate control and synchronization signals for signal processing hardware, excitation light emitting diode (e.g., an LED from LedEngin, Inc. of San Jose, Calif.), pumps, and valves used in the system. SiPM voltage bias, discriminator threshold, and amplifier gain were adjusted to provide high (e.g., the highest) sensitivity and dynamic range, and low (e.g., the lowest) dark count for a reference fluorescent solution (e.g., a 100 nM fluorescein from Sigma-Aldrich of St. Louis, Mo., in deionized (DI) water). The excitation LED was biased using an external circuit providing pulses (e.g., 250 ns pulses at 1 MHz frequency). Excitation pulse width and frequency were set to provide high (e.g., the highest) signal-to-noise ratio for reference fluorescence solution. Excitation (480 nm, 1″ diameter band-pass, 2 nm FWHM) and emission filters (530 nm, 1″ diameter band-pass, 2 nm FWHM) were purchased from Thorlabs, Inc. of Newton, N.J. An optical system assembled of lenses, optical tubes and holders (e.g., from Thorlabs) was used to focus light from the microfluidic chip onto the SiPM and also to minimize stray light.

In some embodiments, an optical system comprising of optical housing and lenses may be using to reduce (e.g., minimize) stray light and increase (e.g., maximize) photon collection efficiency from sample (e.g., microplate, fluidic or microfluidic cartridge, lateral or vertical flow assay). The output of discriminator was fed into high-speed counter.

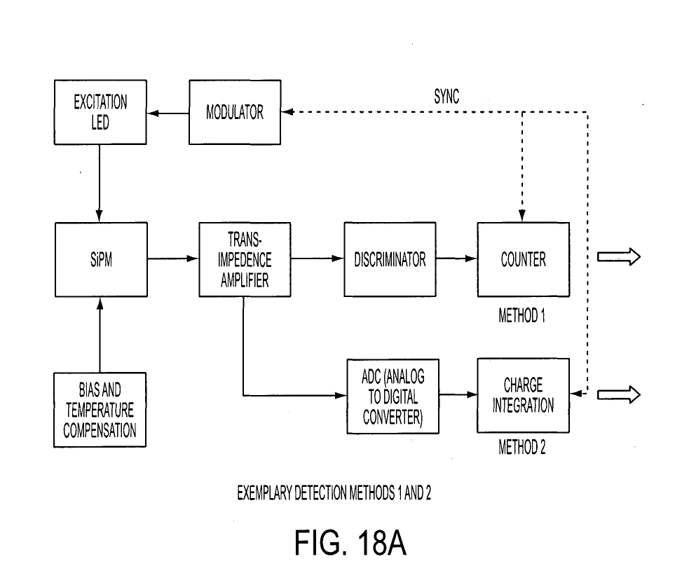

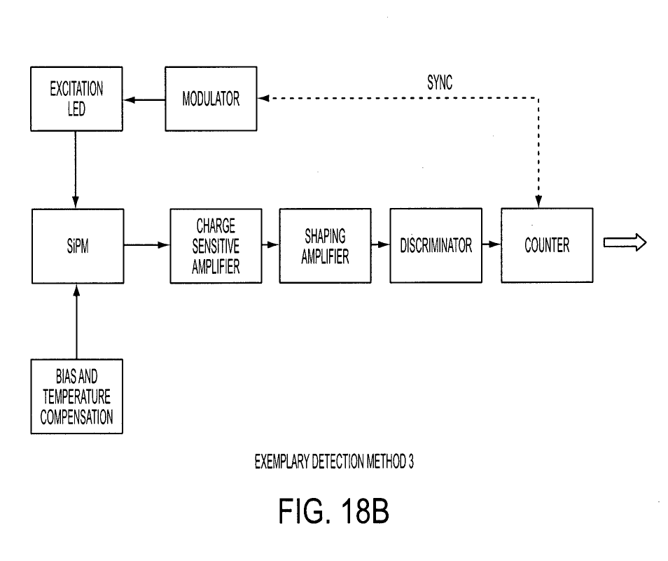

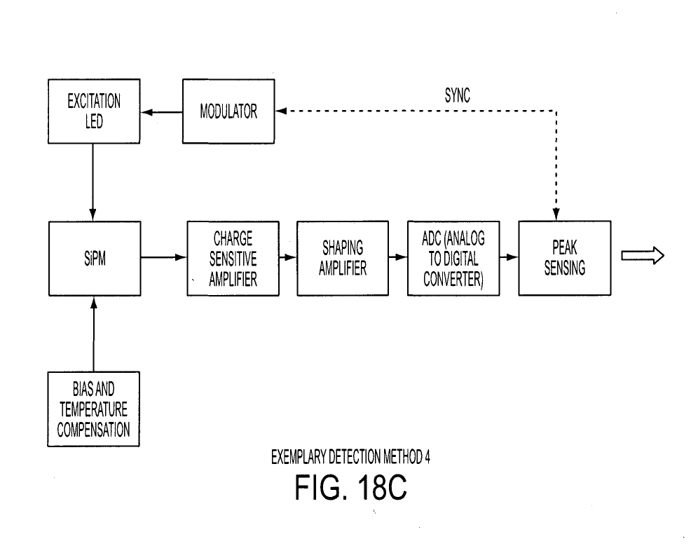

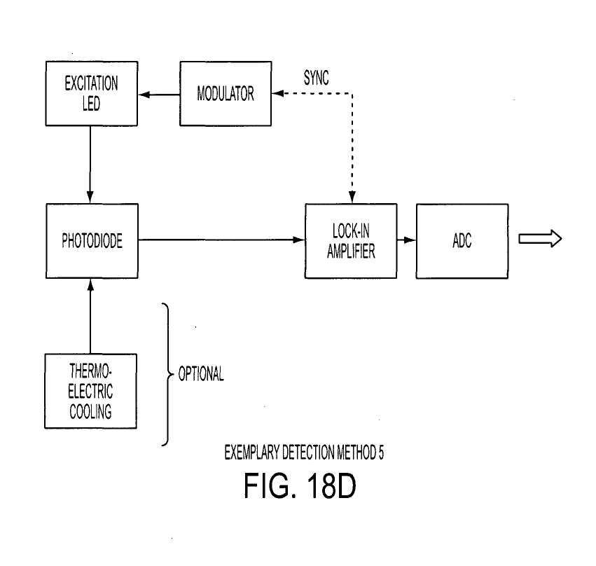

FIGS. 18a-d show exemplary schematics of detection methods that can be used in some embodiments as described herein. Referring to exemplary methods in FIGS. 18a-18c, the SiPM (Silicon photomultiplier) can be substituted with avalanche photodiode or single photon avalanche detector (SPAD).

As shown in FIGS. 18a-18d, for example, the LED generates excitation light at target wavelengths and functions to excite each of the labels and/or fluorescent agents bound to an analyte. The LED output signal can be modulated in order to synchronize signal processing electronics and excitation light. This, in turn, improves signal-to-noise ratio and decreases photo-bleaching of the fluorescent molecule. The label and/or chemical signal then emits light which is collected by a SiPM that has been subjected to bias and temperature compensation. The detected signal then is processed through a transimpendence amplifier, discriminator, and counter (e.g., as shown in method 1) or through a transimpendence amplifier, analog to digital converter (ADC), and charge integration (e.g., as shown in method 2). Synchronization occurs between the counter and a modulator.

As shown in FIG. 18b, for example, the LED generates excitation light at target wavelengths and functions to excite each of the labels and/or fluorescent agents bound to an analyte. The label and/or chemical signal then emits light which is collected by a SiPM that has been subjected to bias and temperature compensation. The signal is then processed through a charge sensitive amplifier, shaping amplifier, discriminator, and counter (e.g., as shown in method 3). Synchronization occurs between the counter and a modulator.

As shown in FIG. 18c, for example, the LED generates excitation light at target wavelengths and functions to excite each of the labels and/or fluorescent agents bound to an analyte. The label and/or chemical signal then emits light which is collected by a SiPM that has been subjected to bias and temperature compensation. The signal is then processed through a charge sensitive amplifier, shaping amplifier, Analog-to-digital converter (ADC), and peak sensing algorithm (e.g., as shown in method 4). Synchronization occurs between peak sensing and a modulator. Thermoelectric cooling is optional for setups in FIGS. 18a-d.

As shown in FIG. 18d, for example, the LED generates excitation light at target wavelengths and functions to excite each of the labels and/or fluorescent agents bound to an analyte. The label and/or chemical signal then emits light which is collected by a SiPM that has been optionally subjected to thermo-electric cooling. The signal is then processed by a lock-in amplifier and ADC. Synchronization occurs between the lock-in amplifier and a modulator.

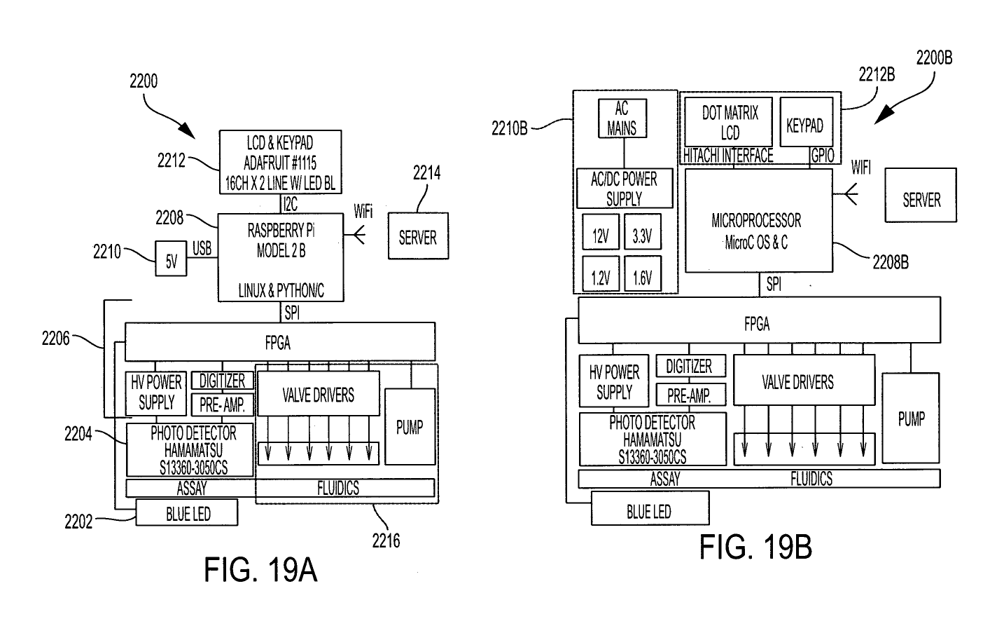

FIG. 19A shows a schematic of an example reader 2200. As depicted, the reader 2200 can include an excitation source 2202, a detector 2204, data processing system 2206, a controller 2208, a power source 2210, a user interface 2212, a network connection 2214, and fluid processing equipment 2216.

The excitation source 2202 can include a light source, such as an LED (e.g., a blue LED) to illuminate the sample within the cartridge. The detector 2204 can include a photo detector in the form of a photon-counting device. In some embodiments, the detector 2204 can include a silicon photomultiplier, such as a Hamamatsu photo detector (e.g., S13360-3050CS model by Hamamatsu Photonics of Japan). The data processing system 2206 can include the various systems and devices described herein, such as field-programmable gate array (FPGA). Additionally, the controller 2208 can include various processor systems. In some examples, the controller 2208 can include a Raspberry Pi microprocessor (e.g., a Raspberry Pi Model 2B) and operate using Linux and Python/C.

The user interface 2212 can include any of various devices by which a user can operate the reader 2200 to perform tests and review results. For example, in some embodiments, the user interface 2212 includes a display device, such as an LCD or LED screen. In some embodiments, the user interface 2212 can also include one or more peripheral components, such as a keyboard or mouse. In some cases, the user interface can include an Adafruit #1115 16 channel, 2 line display with keypad.

The power source 2210 can include any of various electrical power sources based on the controller 2208 and user interface 2212. For example, in some embodiments, the power source 2210 can include a 5 volt (5V) source, which can be in the form of a USB-type connection.

In some embodiments, the network connection 2214 can include a wired or wireless connection (e.g., a Wi-Fi or cellular-type connection (e.g., 3G, 4G, 4G LTE, etc.)). The network connection 2214 can be used to connect the reader to other networks to upload and/or download information regarding patients or test results.

The fluid processing equipment 2216 can include various pumps (e.g., liquid and/or air pumps) to move fluid, such as the sample, dilution fluid, developer, analyte, amplifier, buffer fluid, air, and any other various fluids throughout the cartridge.

FIG. 19B illustrates a schematic of another example reader. Unless otherwise stated, components of the example FIG. 19B can be similar or the same as those of FIG. 19A. Additionally, unless otherwise stated, the components of reader 2200 and reader 2200B can be combined in any of various configurations. As depicted, in some embodiments, a reader 2200B can alternatively include an AC power source 2210B, for example, an AC-DC power supply that can output 12V, 3.3V, 1.8V, or 1.2V. The reader 2200B can include a controller 2208B that includes a microprocessor, which operates using MicroC OS &C. Additionally, the user interface 2212B can include separate display (e.g., dot matrix LCD display) and keypad that can be connected to the controller 2208B.

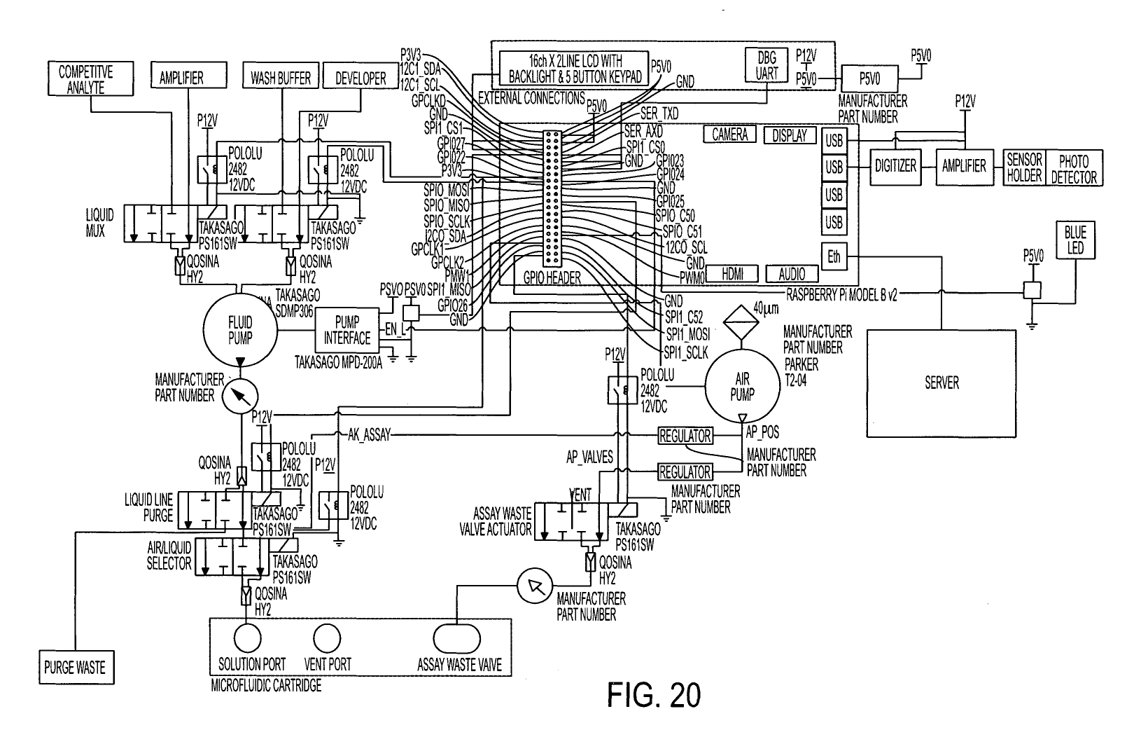

FIG. 20. illustrates another example of a schematic of reader device. For example, FIG. 20 depicts a combined electrical, pneumatic, and hydraulic schematic illustrating a prototype of an automated reader device similar to that shown in FIG. 19A. FIG. 20 illustrates in detail an example embodiment of a Raspberry Pi computer controlling a series of valves and pumps to automatically manage the delivery of assay reagents to a microfluidic cartridge. In this example, four liquids and an air supply are multiplexed using solenoid valves to the single Solution Port inlet of a microfluidic cartridge. The on-chip valve is controlled using a separate pneumatic source and valve. The valves, along with the pump, are controlled by software operating on the Raspberry Pi computer such that the computer can automate the delivery of the assay reagents into the cartridge. FIG. 20 also illustrates how the Raspberry Pi may be integrated with an excitation LED and photo detector to read the assay performed on the microfluidic cartridge. In this example, the Raspberry Pi controls the operation of the excitation LED and reads the corresponding measurement of the assay performance from the amplified, digitized photo detector output. With control over the fluid handling, excitation LED, and photo detector measurement, the Raspberry Pi computer is able to completely automate an assay on the microfluidic cartridge.

While the reader devices described herein have been substantially described as being used in conjunction with the microfluidic cartridges described herein, other implementations are possible. For example, in some embodiments, the reader devices described herein can be configured to analyze traditional microplates (e.g., microwell plate). The size of SiPM chip allows integration of SiPM arrays on the same printed circuit board with pre-amplifiers, analog-to-digital converters and digital signal processing electronics (e.g., FPGA or DSP). Using 8×1, 12×1 and 8×12 array formats one can use SiPM detectors to simultaneously measure signal from microwell plates. Optical elements such as lenses, optical fibers, mirrors and gratings may be used to improve light collection efficiency and allow wavelength multiplexing. Filters can be to select excitation and emission wavelengths.

Additionally, while the detectors herein are generally described as being silicon photomultipliers, other types of a solid-state photomultipliers can be used.

### Cloud Network Environment and Computing Device

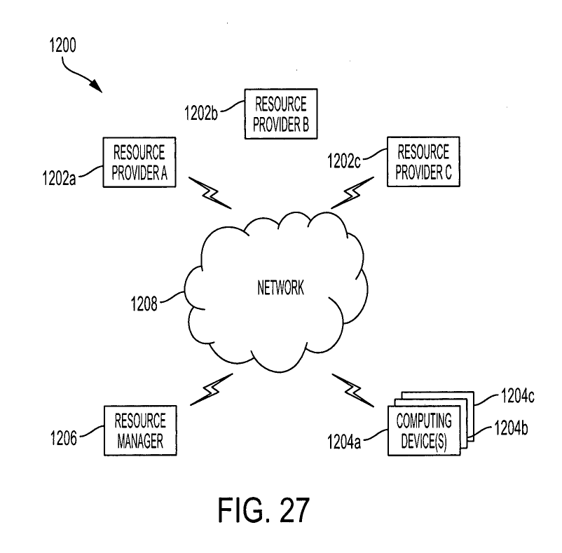

FIG. 27 shows an illustrative network environment 1200 for use in the methods and systems for analysis of spectrometry data corresponding to particles of a sample, as described herein. In brief overview, referring now to FIG. 27, a block diagram of an exemplary cloud computing environment 1200 is shown and described. The cloud computing environment 1200 may include one or more resource providers 1202a, 1202b, 1202c (collectively, 1202). Each resource provider 1202 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 1202 may be connected to any other resource provider 1202 in the cloud computing environment 1200. In some implementations, the resource providers 1202 may be connected over a computer network 1208. Each resource provider 1202 may be connected to one or more computing device 1204a, 1204b, 1204c (collectively, 1204), over the computer network 1208.

The cloud computing environment 1200 may include a resource manager 1206. The resource manager 1206 may be connected to the resource providers 1202 and the computing devices 1204 over the computer network 1208. In some implementations, the resource manager 1206 may facilitate the provision of computing resources by one or more resource providers 1202 to one or more computing devices 1204. The resource manager 1206 may receive a request for a computing resource from a particular computing device 1204. The resource manager 1206 may identify one or more resource providers 1202 capable of providing the computing resource requested by the computing device 1204. The resource manager 1206 may select a resource provider 1202 to provide the computing resource. The resource manager 1206 may facilitate a connection between the resource provider 1202 and a particular computing device 1204. In some implementations, the resource manager 1206 may establish a connection between a particular resource provider 1202 and a particular computing device 1204. In some implementations, the resource manager 1206 may redirect a particular computing device 1204 to a particular resource provider 1202 with the requested computing resource.

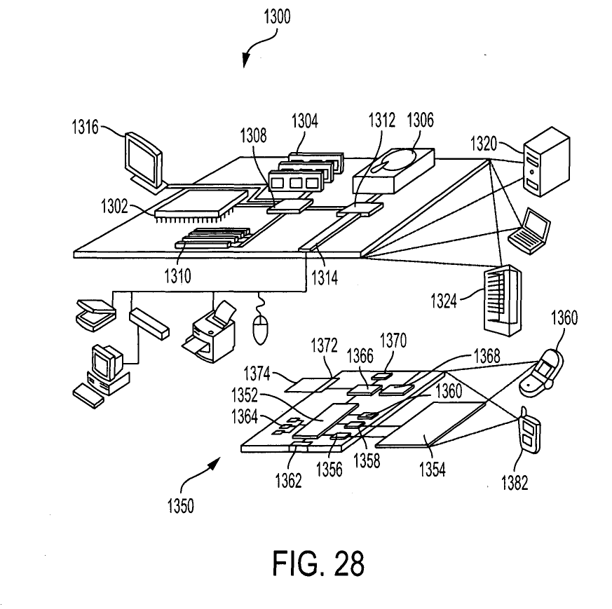

FIG. 28 shows an example of a computing device 1300 and a mobile computing device 1350 that can be used in the methods and systems described in this disclosure. The computing device 1300 is intended to represent various forms of digital computers, such as laptops, desktops, workstations, personal digital assistants, servers, blade servers, mainframes, and other appropriate computers. The mobile computing device 1350 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 1300 includes a processor 1302, a memory 1304, a storage device 1306, a high-speed interface 1308 connecting to the memory 1304 and multiple high-speed expansion ports 1310, and a low-speed interface 1312 connecting to a low-speed expansion port 1314 and the storage device 1306. Each of the processor 1302, the memory 1304, the storage device 1306, the high-speed interface 1308, the high-speed expansion ports 1310, and the low-speed interface 1312, are interconnected using various busses, and may be mounted on a common motherboard or in other manners as appropriate. The processor 1302 can process instructions for execution within the computing device 1300, including instructions stored in the memory 1304 or on the storage device 1306 to display graphical information for a GUI on an external input/output device, such as a display 1316 coupled to the high-speed interface 1308. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 1304 stores information within the computing device 1300. In some implementations, the memory 1304 is a volatile memory unit or units. In some implementations, the memory 1304 is a non-volatile memory unit or units. The memory 1304 may also be another form of computer-readable medium, such as a magnetic or optical disk.

The storage device 1306 is capable of providing mass storage for the computing device 1300. In some implementations, the storage device 1306 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 1302), perform one or more methods, such as those described above. The instructions can also be stored by one or more storage devices such as computer- or machine-readable mediums (for example, the memory 1304, the storage device 1306, or memory on the processor 1302).

The high-speed interface 1308 manages bandwidth-intensive operations for the computing device 1300, while the low-speed interface 1312 manages lower bandwidth-intensive operations. Such allocation of functions is an example only. In some implementations, the high-speed interface 1308 is coupled to the memory 1304, the display 1316 (e.g., through a graphics processor or accelerator), and to the high-speed expansion ports 1310, which may accept various expansion cards (not shown). In the implementation, the low-speed interface 1312 is coupled to the storage device 1306 and the low-speed expansion port 1314. The low-speed expansion port 1314, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 1300 may be implemented in a number of different forms, as shown in the figure. For example, it may be implemented as a standard server 1320, or multiple times in a group of such servers. In addition, it may be implemented in a personal computer such as a laptop computer 1322. It may also be implemented as part of a rack server system 1324. Alternatively, components from the computing device 1300 may be combined with other components in a mobile device (not shown), such as a mobile computing device 1350. Each of such devices may contain one or more of the computing device 1300 and the mobile computing device 1350, and an entire system may be made up of multiple computing devices communicating with each other.

The mobile computing device 1350 includes a processor 1352, a memory 1364, an input/output device such as a display 1354, a communication interface 1366, and a transceiver 1368, among other components. The mobile computing device 1350 may also be provided with a storage device, such as a micro-drive or other device, to provide additional storage. Each of the processor 1352, the memory 1364, the display 1354, the communication interface 1366, and the transceiver 1368, are interconnected using various buses, and several of the components may be mounted on a common motherboard or in other manners as appropriate.

The processor 1352 can execute instructions within the mobile computing device 1350, including instructions stored in the memory 1364. The processor 1352 may be implemented as a chipset of chips that include separate and multiple analog and digital processors. The processor 1352 may provide, for example, for coordination of the other components of the mobile computing device 1350, such as control of user interfaces, applications run by the mobile computing device 1350, and wireless communication by the mobile computing device 1350.

The processor 1352 may communicate with a user through a control interface 1358 and a display interface 1356 coupled to the display 1354. The display 1354 may be, for example, a TFT (Thin-Film-Transistor Liquid Crystal Display) display or an OLED (Organic Light Emitting Diode) display, or other appropriate display technology. The display interface 1356 may comprise appropriate circuitry for driving the display 1354 to present graphical and other information to a user. The control interface 1358 may receive commands from a user and convert them for submission to the processor 1352. In addition, an external interface 1362 may provide communication with the processor 1352, so as to enable near area communication of the mobile computing device 1350 with other devices. The external interface 1362 may provide, for example, for wired communication in some implementations, or for wireless communication in other implementations, and multiple interfaces may also be used.

The memory 1364 stores information within the mobile computing device 1350. The memory 1364 can be implemented as one or more of a computer-readable medium or media, a volatile memory unit or units, or a non-volatile memory unit or units. An expansion memory 1374 may also be provided and connected to the mobile computing device 1350 through an expansion interface 1372, which may include, for example, a SIMM (Single In Line Memory Module) card interface. The expansion memory 1374 may provide extra storage space for the mobile computing device 1350, or may also store applications or other information for the mobile computing device 1350. Specifically, the expansion memory 1374 may include instructions to carry out or supplement the processes described above, and may include secure information also. Thus, for example, the expansion memory 1374 may be provided as a security module for the mobile computing device 1350, and may be programmed with instructions that permit secure use of the mobile computing device 1350. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier and, when executed by one or more processing devices (for example, processor 1352), perform one or more methods, such as those described above. The instructions can also be stored by one or more storage devices, such as one or more computer- or machine-readable mediums (for example, the memory 1364, the expansion memory 1374, or memory on the processor 1352). In some implementations, the instructions can be received in a propagated signal, for example, over the transceiver 1368 or the external interface 1362.

The mobile computing device 1350 may communicate wirelessly through the communication interface 1366, which may include digital signal processing circuitry where necessary. The communication interface 1366 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 1368 using a radio-frequency. In addition, short-range communication may occur, such as using a Bluetooth®, Wi-Fi™, or other such transceiver (not shown). In addition, a GPS (Global Positioning System) receiver module 1370 may provide additional navigation- and location-related wireless data to the mobile computing device 1350, which may be used as appropriate by applications running on the mobile computing device 1350.

The mobile computing device 1350 may also communicate audibly using an audio codec 1360, which may receive spoken information from a user and convert it to usable digital information. The audio codec 1360 may likewise generate audible sound for a user, such as through a speaker, e.g., in a handset of the mobile computing device 1350. Such sound may include sound from voice telephone calls, may include recorded sound (e.g., voice messages, music files, etc.) and may also include sound generated by applications operating on the mobile computing device 1350.

The mobile computing device 1350 may be implemented in a number of different forms, as shown in the figure. For example, it may be implemented as a cellular telephone 1380. It may also be implemented as part of a smart-phone 1382, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. The interface between a user and the computer can also be implemented solely by using a touch screen. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

### Optimization

Assay and nanoparticle optimizations can be performed iteratively so as to speed assay development. Design-of-experiments (DOEs) can be utilized to determine critical parameters as well as their relationships. This can allow optimization of complex matrices with a minimal number of runs. Specific variables to be optimized comprise the concentration of the nanoparticles in the buffer, the concentration of functional ligands on the nanoparticles, and the blood factor dilution. In some embodiments, multiple dilutions per sample can be required to cover the full clinical range.

Capture antibodies can be functionalized on the surface of the microfluidic chamber or on microparticles trapped within the chamber. In some embodiments, microparticle functionalization provides the ability to use the same microfluidic chamber for multiple experiments. Microparticles also offer the additional benefit that different particle populations can be prepared independently and simply mixed for desired multiplexing. However, the use of microparticles adds precision placement requirements. Maximal reproducibility can minimize the number of sample replicates and control samples that must be run. Although larger volumes and increased complexity can be accommodated, understanding these trade-offs can be needed for determining the viability of the technology for producing a clinically useful point of care device.

### Imaging Probes (e.g., Fluorescent Species)

The imaging system and method can be used with a number of different fluorescent imaging probes (or, as in embodiments using a tandem bioluminescent reporter/fluorescent probe, the fluorescent species thereof), for example, (1) probes that become activated after target contact (e.g., binding or interaction) (Weissleder et al., Nature Biotech., 17:375-378, 1999; Bremer et al., Nature Med., 7:743-748, 2001; Campo et al., Photochem. Photobiol. 83:958-965, 2007); (2) wavelength shifting beacons (Tyagi et al., Nat. Biotechnol., 18:1191-1196, 2000); (3) multicolor (e.g., fluorescent) probes (Tyagi et al., Nat. Biotechnol., 16:49-53, 1998); (4) probes that have high binding affinity to targets, e.g., that remain within a target region while non-specific probes are cleared from the body (Achilefu et al., Invest. Radiol., 35:479-485, 2000; Becker et al., Nature Biotech. 19:327-331, 2001; Bujai et al., J. Biomed. Opt. 6:122-133, 2001; Ballou et al. Biotechnol. Prog. 13:649-658, 1997; and Neri et al., Nature Biotech. 15:1271-1275, 1997); and/or (5) quantum dot or nanoparticle-based imaging probes, including multivalent imaging probes, and fluorescent quantum dots such as amine T2 MP EviTags® (Evident Technologies) or Qdot® Nanocrystals (Invitrogen™). The relevant text of the above-referenced documents are incorporated by reference herein. Another group of suitable imaging probes are lanthanide metal-ligand probes. Fluorescent lanthanide metals include europium and terbium. Fluorescence properties of lanthanides are described in Lackowicz, 1999, Principles of Fluorescence Spectroscopy, 2^{nd} Ed., Kluwar Academic, New York, the relevant text incorporated by reference herein. In the methods of this invention, the imaging probes can be administered systemically or locally by injecting an imaging probe or by topical or other local administration routes, such as “spraying”. Furthermore, imaging probes used in the application of this invention can be conjugated to molecules capable of eliciting photodynamic therapy. These include, but are not limited to, Photofrin, Lutrin, Antrin, aminolevulinic acid, hypericin, benzoporphyrin derivative, and select porphyrins.

In general, fluorescent quantum dots used in the practice of this invention are nanocrystals containing several atoms of a semiconductor material (including, but not limited to, those containing cadmium and selenium, sulfide, or tellurium; zinc sulfide, indium-antimony, lead selenide, gallium arsenide, and silica or ormosil), which have been coated with zinc sulfide to improve the properties of the fluorescent agents.

In particular, molecular imaging probes are a preferred type of imaging probe. A molecular imaging probe is a probe that is targeted to a biomarker, molecular structure or biomolecule, such as a cell-surface receptor or antigen, an enzyme within a cell, or a specific nucleic acid, e.g., DNA, to which the probe hybridizes. Biomolecules that can be targeted by imaging probes include, for example, antibodies, proteins, glycoproteins, cell receptors, neurotransmitters, integrins, growth factors, cytokines, lymphokines, lectins, selectins, toxins, carbohydrates, internalizing receptors, enzyme, proteases, viruses, microorganisms, and bacteria.

In some embodiments, fluorophores such as certain carbocyanine or polymethine fluorescent fluorochromes or dyes can be used to construct optical imaging agents, e.g. U.S. Pat. No. 6,747,159 to Caputo, et al. (2004); U.S. Pat. No. 6,448,008 to Caputo, et al. (2002); U.S. Pat. No. 6,136,612 to Della Ciana, et al. (2000); U.S. Pat. No. 4,981,977 to Southwick, et al. (1991); U.S. Pat. No. 5,268,486 to Waggoner, et al. (1993); U.S. Pat. No. 5,569,587 to Waggoner (1996); U.S. Pat. No. 5,569,766 to Waggoner, et al. (1996); U.S. Pat. No. 5,486,616 to Waggoner, et al. (1996); U.S. Pat. No. 5,627,027 to Waggoner (1997); U.S. Pat. No. 5,808,044 to Brush, et al. (1998); U.S. Pat. No. 5,877,310 to Reddington, et al. (1999); U.S. Pat. No. 6,002,003 to Shen, et al. (1999); U.S. Pat. No. 6,004,536 to Leung, et al. (1999); U.S. Pat. No. 6,008,373 to Waggoner, et al. (1999); U.S. Pat. No. 6,043,025 to Minden, et al. (2000); U.S. Pat. No. 6,127,134 to Minden, et al. (2000); U.S. Pat. No. 6,130,094 to Waggoner, et al. (2000); U.S. Pat. No. 6,133,445 to Waggoner, et al. (2000); U.S. Pat. No. 7,445,767 to Licha, et al. (2008); U.S. Pat. No. 6,534,041 to Licha, et al. (2003); U.S. Pat. No. 7,547,721 to Miwa, et al. (2009); U.S. Pat. No. 7,488,468 to Miwa, et al. (2009); U.S. Pat. No. 7,473,415 to Kawakami, et al. (2003); also WO 96/17628, EP 0 796 111 B1, EP 1 181 940 B1, EP 0 988 060 B1, WO 98/47538, WO 00/16810, EP 1 113 822 B1, WO 01/43781, EP 1 237 583 A1, WO 03/074091, EP 1 480 683 B1, WO 06/072580, EP 1 833 513 A1, EP 1 679 082 A1 WO 97/40104, WO 99/51702, WO 01/21624, and EP 1 065 250 A1; and Tetrahedron Letters 41, 9185-88 (2000).

Exemplary fluorochromes for optical imaging probes include, for example, the following: Cy5.5, Cy5, Cy7.5 and Cy7 (GE® Healthcare); AlexaFluor660, AlexaFluor680, AlexaFluor790, and AlexaFluor750 (Invitrogen); VivoTag™680, VivoTag™-S680, VivoTag™-S750 (VisEN Medical); Dy677, Dy682, Dy752 and Dy780 (Dyomics®); DyLight® 547, and/or DyLight® 647 (Pierce); HiLyte Fluor™ 647, HiLyte Fluor™ 680, and HiLyte Fluor™ 750 (AnaSpec®); IRDye® 800CW, IRDye® 800RS, and IRDye® 700DX (Li-Cor®); ADS780WS, ADS830WS, and ADS832WS (American Dye Source); XenoLight CF™ 680, XenoLight CF™ 750, XenoLight CF™ 770, and XenoLight DiR (Caliper® Life Sciences); and Kodak® X-SIGHT® 650, Kodak® X-SIGHT 691, Kodak® X-SIGHT 751 (Carestream Health).

What is claimed:

1. A reader system for optically detecting binding agents and/or analyte complexes in a sample as a result of performing one or more biochemical assays, the reader system comprising:
a housing defining a positioning receptacle configured to receive the sample;
an excitation source to generate incident light directed at the sample;
at least one solid-state photomultiplier detector configured to: i) receive a light emitted by at least one label associated with the binding agents and/or analyte complexes within the sample or from a substrate solution chemically or physically modified by the label; and ii) produce a signal in response to receiving the light, the at least one detector being connected to integrated signal processing electronics to process the signal; and
a user interface in communication with the signal processing electronics for conveying one or more results of the one or more biochemical assays.

2. The reader system of claim 1 wherein the excitation source comprises a light emitting diode.

3. The reader system of claim 1 wherein the excitation source comprises a laser or a laser diode.

4. The reader system of claim 1 where the incident light comprises narrow band light.

5. The reader system of claim 1 wherein the incident light comprises broadband excitation light.

6. The reader system of claim 4 wherein the excitation light comprises light at a wavelength of about 280 nm to about 800 nm.

7. The reader system of claim 1 wherein the incident light generated by the excitation source is modulated.

8. The reader system of claim 1 wherein the excitation light source and signal processing electronics are synchronized with one another using a trigger signal.

9. The reader system of claim 1 wherein the signal comprises a fluorescence optical signal.

10. The reader system of claim 1 wherein the signal comprises a luminescence optical signal.

11. The reader system of claim 10 wherein the luminescence optical signal comprises a chemiluminescence optical signal.

12. The reader system of claim 11 wherein the chemiluminescence optical signal comprises an electrochemiluminescence optical signal.

13. The reader system of claim 1 wherein the signal comprises an absorbance optical signal.

14. The reader system of claim 1 wherein detector signal is amplified using voltage or charge sensitive pre-amplifier.

15. The reader system of claim 1 wherein the signal processing comprises photon counting, photon counting histogram, charge integration, pulse-height spectroscopy, energy spectroscopy, and/or lock-in amplification.

16. The reader system of claim 11 wherein an analyte concentration is correlated to a signal processing output.

17. The reader system of claim 1 wherein the at least one label comprises released contents of an engineered nanoparticles.

18. The reader system of claim 1 wherein the integrated signal processing electronics comprises at least one of an amplifier, a signal shaping amplifier, a signal height discriminator, a field-programmable gate array chipset, microcontroller, or a microprocessor.

19. The reader system of claim 14 wherein the signal processing is implemented digitally on an FPGA or DSP comprising algorithms for zero-pole cancellation, shaping, timing, pulse counting and/or pulse integration.

20. The reader system of claim 1 further comprising a transmitter configured to communicate with an external network.

21. The reader system of claim 1 wherein the sample is disposed in an optically transparent element disposed within the reader system.

22. The reader system of claim 21 wherein the optically transparent element comprises a microwell plate.

23. The reader system of claim 1 further comprising a microfluidic cartridge configured to receive the sample.

24. The reader system of claim 23 wherein the housing comprises one or more articulation features to cause or limit fluid flow through the cartridge.

25. The reader system of claim 24 wherein the one or more articulation features comprises at least one of a pneumatic actuator, a hydraulic actuator, a solenoid or motor driven actuator, a cam actuator, an electrostatic actuator, and/or a thermal actuator.

26. The reader system of claim 1 wherein the user interface comprises a display.

27. The reader system of claim 1 wherein the solid-state photomultiplier comprises a silicon photomultiplier.

28. The reader system of claim 7 wherein the modulated light is pulsed for a duration of about 10 picoseconds to about 1 second.

29. The reader system of claim 1 wherein the reader system comprises at least one optical element to manipulate light directed to, or emitted from the sample.

30. The reader system of claim 29 wherein the at least one optical elements comprises at least one of a filter, an objective, a lens, a mirror, a dichroic mirrors, fiber optics components, or a grating.

31. A system for facilitating performance of one or more biochemical assays on a sample, the system comprising:
a microfluidic cartridge sized and shaped to be received within a corresponding reader, the cartridge comprising:
a substrate body;
at least one inlet on the substrate body to receive the sample;
a microfluidic network to distribute fluids through the cartridge; and
an assay chamber in which a portion of the sample is disposed and can be combined with one or more binding agents and/or analyte complexes so that the biochemical assay can be performed; and
a reader system comprising:
a housing defining a positioning receptacle to receive and couple to the cartridge;
an excitation source to generate incident light directed at the assay chamber within the cartridge;
at least one solid-state photomultiplier detector configured to: i) receive a light emitted by at least one label associated with the binding agents and/or analyte complexes within the sample or from a substrate solution chemically or physically modified by the label; and ii) produce a signal in response to receiving the light, the at least one detector being connected to integrated signal processing electronics to process the signal; and
a user interface in communication with the signal processing electronics for conveying one or more results of the one or more biochemical assays.

32. The system of claim 31 wherein the excitation source comprises a light emitting diode.

33. The system of claim 31 wherein the excitation source comprises a laser.

34. The system of claim 31 wherein the excitation source comprises a laser diode.

35. The system of claim 31 wherein the excitation source comprises a narrow band source.

36. The system of claim 31 wherein the excitation source comprises a broadband source.

37. The system of claim 31 wherein the incident light comprises excitation light.

38. The system of claim 31 wherein the incident light generated by the excitation source is pulsed for a duration of about 10 picoseconds to about 1 second.

39. The system of claim 31 wherein the reader system comprises at least one optical element to manipulate light directed to, or emitted from the sample.

40. The system of claim 39 wherein the at least one optical elements comprises at least one of a filter, an objective, a lens, a mirror, a dichroic mirrors, fiber optics components, or a grating.

41. The system of claim 31 wherein the at least one silicon photomultiplier detector comprises a cooled detector.

42. The system of claim 31 further comprising at least one detector that is a photodiode, an avalanche photodiode, a photodiode array, a CMOS sensor, or a single photon avalanche detector.

43. The system of claim 31 wherein the signal from the detector is amplified using voltage or charge sensitive pre-amplifier and the amplified signal is filtered to limit high frequency noise.

44. The system of claim 31 wherein the at least one label associated with the binding agent and/or analyte complexes comprises at least one label that is bound to and/or released from the one or more binding agent and/or analyte complexes.

45. The system of claim 31 wherein the integrated signal processing electronics comprise at least one of an amplifier, a signal shaping amplifier, a signal height discriminator, a field-programmable gate array chipset, microcontroller, or a microprocessor.

46. The system of claim 31 wherein the reader system further comprises a transmitter configured to communicate with an external network.

47. The system of claim 46 wherein the external network comprises a cloud network system or the Internet.

48. The system of claim 31 wherein the user interface comprises a touchscreen display.

49. The system of claim 31 wherein the housing comprises one or more articulation features to cause or limit fluid flow through the cartridge.

50. The system of claim 31 wherein the microfluidic cartridge comprises a metering chamber in which a predefined volume of fluid can be formed.

51. The system of claim 50 wherein the microfluidic cartridge comprises a valve upstream or downstream of the metering chamber to limit flow of the fluid into the metering chamber.

52. The system of claim 51 wherein the reader comprises an actuator to operate the valve between an open state and a closed state.

53. The system of claim 52 wherein the actuator comprises one or a combination a pneumatic actuator, a hydraulic actuator, a solenoid or motor driven actuator, a cam actuator, an electrostatic actuator, and/or a thermic actuator.

54. The system of claim 50 wherein the microfluidic cartridge comprises an overflow channel through which the fluid can flow to bypass entering the metering chamber.

55. The system of claim 54 wherein the fluid bypasses entering the chamber in response to a valve downstream of the metering chamber being closed to limit flow of the fluid into the metering chamber.

56. The system of claim 54 wherein the fluid bypasses entering the chamber in response to a valve upstream of the metering chamber being closed to limit flow of the fluid into the metering chamber.

57. The system of claim 31 wherein the microfluidic cartridge comprises a waste chamber for storing biohazardous waste.

58. The system of claim 31 wherein the microfluidic cartridge comprises more than one inlet and/or a manifold to receive more than one fluid for distribution throughout the microfluidic network.

59. The system of claim 31 wherein the cartridge comprises binding agents and/or analyte complexes that are immobilized on a surface of the assay chamber.

60. The system of claim 59 wherein the binding agents and/or analyte complexes are immobilized on a plurality of magnetic beads.

61. The system of claim 60 wherein the plurality of magnetic beads are stored off-cartridge and sized and shaped for injection through one of the at least one port on the cartridge.

62. The system of claim 60 wherein an external magnetic field is used to localize magnetic beads.

63. The system of claim 31 wherein the microfluidic cartridge is substantially free of wet reagents.

64. The system of claim 63 wherein the wet reagents are stored in a separate reservoir disposed within the housing.

65. The system of claim 31 wherein the solid-state photomultiplier comprises a silicon photomultiplier.

66. The system of claim 31 wherein the signal comprises a fluorescence optical signal.

67. The system of claim 31 wherein the signal comprises a luminescence optical signal.

68. The system of claim 67 wherein the luminescence optical signal comprises a chemiluminescence optical signal.

69. The system of claim 68 wherein the chemiluminescence optical signal comprises an electrochemiluminescence optical signal.

70. The system of claim 31 wherein the signal comprises an absorbance optical signal.

71. A single-use microfluidic cartridge to be inserted within a corresponding reader system for optically detecting binding agents or analyte complexes in a sample as a result of performing one or more biochemical assays, the microfluidic cartridge comprising:
a cartridge body that is sized and shaped to be received within an opening of corresponding reader, the cartridge body comprising:
at least one inlet to receive one or more fluids, the one or more fluids comprising the sample;
a metering module configured to produce a predetermined volume of the sample from at least one of the at least one inlets, the metering module comprising a valve to selectively limit flow of the sample the assay chamber;
an assay chamber in which a portion of the sample is disposed and can be combined with one or more binding agents and/or analyte complexes so that the biochemical assay can be performed;
a microfluidic network to distribute fluids through the cartridge; and
a pressure generating device to cause fluid to flow through the microfluidic network from the inlet to the assay chamber.

72. The single-use microfluidic cartridge of claim 71 wherein the metering module comprises a metering chamber in which a predefined volume of fluid can be formed.

73. The single-use microfluidic cartridge of claim 72 wherein the valve is disposed downstream of the metering chamber to limit flow of the fluid into the metering chamber.

74. The single-use microfluidic cartridge of claim 72 wherein the valve is disposed upstream of the metering chamber to limit flow of the fluid into the metering chamber.

75. The single-use microfluidic cartridge of claim 73 wherein the valve is configured to be operated between an open state and a closed state by an external actuator.

76. The single-use microfluidic cartridge of claim 75 wherein the external actuator comprises one or a combination a pneumatic actuator, a hydraulic actuator, a solenoid or motor driven actuator, a cam actuator, an electrostatic actuator, and/or a thermic actuator disposed in or on the corresponding reader system.

77. The single-use microfluidic cartridge of claim 72 wherein the microfluidic cartridge comprises an overflow channel through which the fluid can flow to bypass entering the metering chamber.

78. The single-use microfluidic cartridge of claim 77 wherein the fluid bypasses entering the chamber in response to the valve being closed to limit flow of the fluid into the metering chamber.

79. The single-use microfluidic cartridge of claim 71 wherein the microfluidic cartridge comprises a waste chamber for storing biohazardous waste.

80. The single-use microfluidic cartridge of claim 71 wherein the at least one inlet comprises more than one inlet and/or a manifold to receive more than one fluid.

81. The single-use microfluidic cartridge of claim 71 further comprising binding agents and/or analyte complexes that are immobilized on a surface of the assay chamber.

82. The single-use microfluidic cartridge of claim 81 wherein the binding agents and/or analyte complexes are immobilized on a plurality of magnetic beads.

83. The single-use microfluidic cartridge of claim 71 wherein the assay chamber serves as a dilution chamber.

84. The single-use microfluidic cartridge of claim 71 wherein the assay chamber serves as a portion of the metering module.

85. The single-use microfluidic cartridge of claim 84 wherein the assay chamber comprises a metering chamber in which a volume of the sample is measured.

86. The single-use microfluidic cartridge of claim 71 wherein a portion of the cartridge comprises an optical detection zone within at least a portion of the assay chamber.

87. The single-use microfluidic cartridge of claim 86 wherein the detection zone is substantially optically transparent.

88. The single-use microfluidic cartridge of claim 87 wherein the substantially optically transparent comprises light transmission that is greater than about 80%.

89. The single-use microfluidic cartridge of claim 71 wherein the microfluidic cartridge is substantially free of wet reagents.

90. The single-use microfluidic cartridge of claim 71 wherein the microfluidic cartridge comprises a dried or lyophilized reagent that can be reconstituted.

91. The single-use microfluidic cartridge of claim 71 further comprising a filtering module to separate a fluid sample.

92. The single-use microfluidic cartridge of claim 71 further comprising a dilution module.

93. The single-use microfluidic cartridge of claim 92 wherein the dilution module comprises a ratiometric mixing module.
